(19) United States
(12) Patent Application Publication
(10) Pub. No.: US 2025/0128136 A1
(43) Pub. Date: Apr. 24, 2025

(54) SYSTEM, METHOD AND/OR COMPUTER READABLE MEDIUM FOR DETERMINING READ OF A PUTT

(71) Applicant: TURBO BUZZER INC., Toronto (CA)

(72) Inventors: Stephen J. RAITT, Ancaster (CA); Thomas A. SNOPEK, Ancaster (CA); Douglas G. BRAJER, Toronto (CA); Ralph BAUER, Simcoe (CA)

(73) Assignee: TURBO BUZZER INC., Toronto, ON (CA)

(21) Appl. No.: 18/685,052

(22) PCT Filed: Aug. 19, 2022
(86) PCT No.: PCT/CA2022/051262

§ 371 Date: Feb. 20, 2024

Related U.S. Application Data
(60) Provisional application No. 63/235,390, filed on Aug. 20, 2021.

(51) Int. Cl. A63B 69/36; A63B 71/06

(52) U.S. Cl. CPC A63B 69/3676; A63B 71/0622; A63B 2220/18; A63B 2220/20; A63B 2220/44; A63B 2220/807

(57) ABSTRACT

The present disclosure provides a method for determining a read of a putt is disclosed. The method includes receiving a magnitude of slope parameter, a length of putt parameter and a greed speed parameter, and then calculating a break and a pace based on the magnitude of slope parameter, the length of putt parameter and the green speed parameter. The read of the putt includes the break and the pace. If additional accuracy is required, the method includes receiving an adjusted magnitude of slope parameter, an adjusted length of putt parameter or an adjusted green speed, and then re-calculating the break and pace. If additional accuracy is not required, the break and pace may be displayed on a graphical user interface to aid a user to hit a golf ball according to the read of the putt.

### CROSS-REFERENCE TO RELATED APPLICATIONS

This application is a national phase entry of PCT Patent Application Serial No. PCT/CA2022/051262, filed on Aug. 19, 2022, which claims priority to U.S. Provisional Patent Application Ser. No. 63/235,390, filed on Aug. 20, 2021, both of which are incorporated by reference herein.

### TECHNICAL FIELD

The present disclosure relates to a system, method and computer readable medium for determining the read of a putt. More specifically, to a system, method and computer readable medium for calculating the break and pace of a putt based on the environment to aid a golfer in sinking a putt.

### BACKGROUND

In the game of golf, putting involves a combination of skills that players continually seek to perfect. Professional and ambitious golfers spend many hours practicing putting to improve their score by even one or two fewer strokes per round. For professional golfers, a single stroke gained putting per round would translate into four strokes saved over the course of a typical 4-round tournament. This could easily be the difference between earning no money at a tournament (“missing the cut”) and winning a tournament with a seven figure payday.

One major skill is the ability to “read” the putting green, estimating the optimal start direction and appropriate speed (or “pace”) required to stroke the ball for any given putt. “Reading” gives the player the best chance of making a particular putt as well as the best chance to keep the ball close to the hole in the event that the putt misses.

The optimal read (optimal start direction and pace) is primarily determined by the length of the putt and the surface conditions of the green: (i) the slope of the green, (ii) the direction of that slope (the “fall line”), and (iii) the speed of the green. The “green speed” is primarily a measure of the amount of friction that affects the rolling golf ball. This friction is determined by many factors, including the type of grass, the length of the grass, the consistency of the surface (bumpy vs. smooth), the moisture content of the grass (dry vs. wet) and even the direction that the grass grows (often referred to as the “grain”). While the topography of a green remains constant from day to day, the green speed can vary significantly based on numerous environmental factors (when was the green last cut or rolled, moisture, time of day, etc.). Golf course operators do not generally publish or even measure green speeds.

One way to describe the optimal start direction of a putt is to estimate a target distance left or right of the hole. This amount is commonly referred to as the “break.” A ball struck in the correct starting direction with correct pace will then turn or “break” this amount into the hole.

Break and pace are interconnected. If the pace a putt is struck with is too fast, the ball will not break as much along an estimated path. If the pace is too slow, the ball will break more. Thus, the golfer's ability to read the green conditions, estimate the break, and then calibrate the required pace is essential to improved putting.

Golfers often use practice aids to help improve their putting. While practice aids are not permitted under the rules of golf to be used during a round, they are used while practicing outside of official play to help the golfer train, learn, and internalize various putting skills.

Many devices, software applications, and visual aids have been developed to help golfers train a subset of the skills required for good putting.

Some physical devices have been developed to help train putting pace by helping the golfer to feel and internalize the motion of striking the ball. Patent U.S. Pat. No. 7,278,924B2 describes an artificial “hole” with raised edges, which requires a specific amount of putting force for the ball to enter and stay inside. Patent U.S. Pat. No. 9,044,661B2 describes an artificial putting surface with sensors that measure the travel of a putt and lights to signal accuracy in such a way that the golfer remains in an ideal stance to internalize muscle memory for the stroke.

Other physical devices have been developed to help estimate slope by using a level-measuring apparatus. Patent U.S. Pat. No. 5,209,470A describes a specially-designed putter clubhead containing a spirit level, designed to provide a qualitative measurement of slope when placed over the hole. Technically, this could help the golfer to identify the fall line for a putt, but it would require multiple measurements with the spirit level in different orientations to do so.

Some devices are capable of measuring slope and providing an indication of optimal start direction. Patent U.S. Pat. No. 6,890,273B1 describes a device using an ultrasonic rangefinder to read the green surface between the ball and the hole and measure slope variances along the putting line. Patent U.S. Pat. No. 6,165,083A describes an electronic level-measuring device mounted onto a putter, which calculates a putt offset distance based on a measured slope.

A golfer with an estimate of slope may also refer to visual aids such as “break charts,” which display a summary of how far a ball will break for slopes of different angles over increasing distances. Use of some charts may be allowed under official rules of golf because they serve as prediction aids without showing the golfer an actual predicted line for their putt. One example is Patent U.S. Pat. No. 8,162,779B1, which describes a chart developed from “common principles of golf green architecture to simulate how putts would behave on typical putting surfaces.” Patent U.S. Pat. No. 6,638,173B2 describes a more detailed type of chart that shows slope measurements and lines of travel on pre-mapped green topographies, and also incorporates an “average speed value” for the green. Break charts may be a useful aid for actual play, but they do not provide a way of identifying what the actual slope or green speed for a specific putt might be, which makes them impractical for use in putting training.

Smartphones and similar mobile devices contain sensors which are capable of measuring the slope of a surface. Prior inventions have combined this information with pre-mapped and stored topographies to display an estimated break line for a specific putt. As examples, patents US20130085018A1 and U.S. Pat. No. 9,597,576B2 describe applications that allow marking of the ball and hole and use topography to predict the line of travel from one to the other.

Physical devices have been developed for measuring green speed, including the United States Golf Association-approved “Stimpmeter” (as described in Patent US20150204777A1). These devices typically use specifically-sloped ramps to roll balls consistently across a green surface, where distance of travel indicates green speed.

### SUMMARY

According to various aspects to the present invention, a method for determining a read of a putt is disclosed. The method includes receiving a magnitude of slope parameter, a length of putt parameter and a green speed parameter, and then calculating a break and a pace based on the magnitude of slope parameter, the length of putt parameter and the green speed parameter. The read of the putt may also include calculating the break and the pace, such as where additional accuracy is required. If additional accuracy is required, the method includes receiving an adjusted magnitude of slope parameter, an adjusted length of putt parameter or an adjusted green speed, and then re-calculating the break and pace. Where additional accuracy is required, the break and pace may be displayed on a graphical user interface to aid a user to hit a golf ball according to the read of the putt.

The method for determining the read of the putt may further include measuring the magnitude of slope parameter using an inertial measurement unit.

In addition, the method for determining the read of the putt may further include using a camera to take a photograph of the distance between a starting position and a targeted hole, and using image analysis to measure the distance.

Furthermore, the method for determining the read of the putt may also include receiving a second magnitude of slope parameter, averaging the first magnitude of slope parameter with the second magnitude of slope parameter, and re-calculating the break and the pace suing the averaged magnitude of slope parameter.

According to various aspects to the present invention, a non-transitory computer-readable medium including instructions executable by a processor to receive a magnitude of slope parameter, a length of putt parameter and a green speed parameter, the processor to further determine a break and pace based on the magnitude of slope parameter, the length of putt parameter and the green speed parameter is disclosed. The processor may also receive and adjust the magnitude of slope parameter, adjust the length of putt parameter or adjust the green speed parameter if it is determined that the break and pace are not accurate. The processor may then re-calculate the break and the pace based on the adjusted magnitude of slope parameter, the adjusted length of putt parameter, or the adjusted green speed parameter. The processor may then provide the break and pace as a read of a putt to be displayed on a graphical user interface.

An aspect of the present invention may also be directed to the non-transitory computer-readable medium including instructions executable by a processor, where the magnitude of slope parameter is measured using an inertial measurement unit.

A further aspect of the present invention may be directed to the non-transitory computer-readable medium including instructions executable by a processor, where the length of the putt parameter is measured by taking a photograph of a distance between a starting position and a targeted hole and using image analysis to determine the distance.

A further aspect of the present invention may be directed to the non-transitory computer-readable medium including instructions executable by a processor, where the processor is further configured to receive a second magnitude of slope parameter, average the second magnitude of slope parameter with the first magnitude of slope parameter, and re-calculate the break and the pace with the averaged magnitude of slope parameter.

According to various aspects to the present invention, a method for teaching a golfer a desired path of a golf ball to a hole on a putting green. The method includes placing a device at a first location on the putting green, the first location between the golf ball and the hole, and the device determining a magnitude of slope parameter, a length of putt parameter and a green speed parameter. The method further includes the device calculating the desired path on the putting green based on the device determining a break and pace of the putting green for the magnitude of slope parameter, the length of putt parameter and the green speed parameter determined in the first step of placing a device at a first location on the putting green. The method also includes displaying at least one of the desired path, the break or the pace on the device to allow the golfer to drive the golf ball to the hole. The method further includes the golfer putting the ball using the break and the pace to drive the ball along the desired path to the hole. In addition, where the ball does not reach the hole, the golfer repeating the steps of placing the device at a first location on the green, calculating the desired path on the putting green and displaying at east one of the desired path, and adjusting at least one of the magnitude of slope parameter, the length of putt parameter and the green speed parameter until the ball reaches the hole.

The magnitude of slope parameter may be measured using an inertial measurement unit.

### BRIEF DESCRIPTION OF THE DRAWINGS

Embodiments are described with reference to the following figures, in which:

FIG. 1 depicts an example system for determining the read of a putt;

FIG. 2 depicts an example method for determining the read of a putt in the system of FIG. 1;

FIG. 3 depicts an example trajectory of a putt, the break and the pace, where the putt is for an uphill, right-to-left breaking putt;

FIG. 4 depicts an example trajectory of a putt and the different zones for different paces, where the putt is for an uphill, right-to-left breaking putt;

FIG. 5 depicts an alternate example trajectory of a putt and the different zones for different paces, where the putt is for a downhill, left-to-right breaking putt;

FIG. 6 depicts an example user interface for determining the read of a putt;

FIG. 7 depicts an example user interface for measuring the slope;

FIG. 8 depicts an example user interface for displaying the resultant read of the putt;

FIG. 9 depicts an example user interface where the green speed is adjusted;

FIG. 10 depicts an example user interface where the length of the putt is adjusted;

FIG. 11 depicts an example user interface where the proposed trajectory of the golf ball is shown;

FIG. 12 depicts an example user interface for measuring an additional slope;

FIG. 13 depicts an example user interface for displaying the resultant read of the putt after an additional slope has been measured;

FIG. 14 depicts an example user interface for displaying the resultant read of the putt after an additional slope has been measured and then averaged with the previous measured slope;

FIG. 15 depicts calculations for an example two putts, the first putt downhill with a start angle α and a second putt uphill with start angle β;

FIG. 16 depicts an example user interface for displaying a chart for a specific green speed with multiple estimated break values based on various lengths of putt and various magnitudes of slope;

FIG. 17 depicts an example user interface for displaying the warning that live measurement functions are locked out;

FIG. 18 depicts an example user interface displaying the availability of training and calibrate features;

FIG. 19 to FIG. 27 depicts examples of user interfaces that teach a user on how to use the application;

FIG. 28 depicts an example media library for displaying tutorials, help, and training information via images, videos, links and other media formats;

FIGS. 29 to 31 depicts examples of user interfaces for the calibration of the mobile device to be used in the mobile application; and

FIG. 32 depicts an example user interface of the account settings.

### DETAILED DESCRIPTION OF THE PREFERRED EMBODIMENTS

The description, which follows, and the embodiments described therein are provided by way of illustration of an example, or examples of particular embodiments of principles and aspects of the present invention. These examples are provided for the purposes of explanation and not of limitation, of those principles of the invention. In the description that follows, like parts are marked throughout the specification and the drawings with the same respective reference numerals.

It should also be appreciated that the present invention can be implemented in numerous ways, including as a process, a method, an apparatus, a system, or a device.

None of the prior art provides a complete solution for measuring and estimating slope, break, and green speed together. Furthermore, none of the prior art trains the golfer to calibrate their stroke pace to match the current conditions. The below embodiment aims to solve at least one of the aforementioned problems described above.

By way of general overview, there is provided a system and method of providing a complete model of the current putting conditions, helping golfers develop the skills to improve not only their green reading but also to improve the physical components of putting.

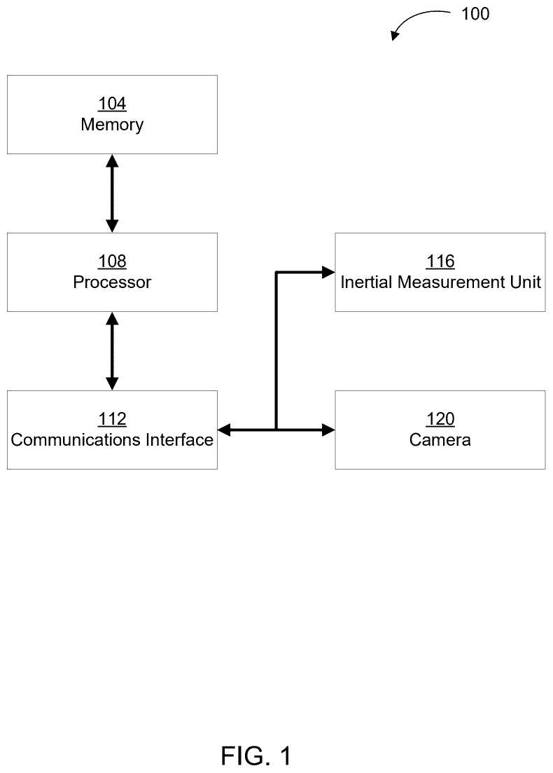

FIG. 1 depicts a system 100 for determining the read of a putt. System 100 may be implemented with computer systems or mobile devices which are well known in the art. Generally speaking, computers and mobile devices include a central processor, system memory, and a system bus that couples various system components (typically provided on cards), including the system memory, to the central processor. A system bus may be any of several types of bus structures including a memory bus or memory controller, a peripheral bus, and a local bus using any of a variety of bus architectures. The structure of a system memory may be well known to those skilled in the art and may include a basic input/output system (BIOS) stored in a read only memory (ROM) and one or more program modules such as operating systems, application programs and program data stored in random access memory (RAM). Computers and mobile devices may also include a variety of interface units and drives for reading and writing data. A user can interact with the computer or mobile device with a variety of input devices, all of which are known to a person skilled in the relevant art. Computers or mobile devices can operate in a networked environment using local connections to one or more remote computers or other devices, such as a server, a router, a network personal computer, a peer device or other common network node, a wireless telephone or wireless personal digital assistant.

System 100 may include a processor 108 interconnecting a memory 104 and a communications interface 112. System 100 may further include inertial measurement unit 116 and camera 120 in communication with processor 108 via communications interface 112. In alternate embodiments, inertial measurement unit 116 and camera 120 may be directly connected to processor 108 to send and receive data.

Processor 108 can include a central-processing unit (CPU), a microcontroller, a microprocessor, a processing core, a field-programmable gate array (FPGA), or similar. The processor 108 can include multiple cooperating processors. Processor 108 can cooperate with non-transitory computer readable medium such as memory 104 to execute instructions to realize the functionality discussed herein.

Memory 104 can include a combination of volatile (e.g. Random Access Memory or RAM) and non-volatile memory (e.g. read only memory or ROM, Electrically Erasable Programmable Read Only memory or EEPROM, flash memory). All or some of the memory 104 can be integrated with processor 108. Memory 104 stores computer readable instructions for execution by processor 108.

In particular, memory 104 stores a plurality of applications, each including a plurality of computer readable instructions executable by processor 108. In particular, the execution of the instructions in memory 104 by processor 108 determines the read of a putt, including the break and pace of the putt for a player to reach the targeted hole. A person skilled in the art will now recognize that various forms of computer-readable programming instructions stored in memory 104 can be executed by processor 108 as applications or queries.

Memory 104 further stores a calibration application for interpreting the outputs of inertial measurement unit 116 to account for differences in manufacturing tolerances and physical wear to inertial measurement unit 116 over time. Said calibration application will be further discussed below.

System 100 also includes communications interface 112 interconnected with processor 108. Communications interface 112 includes suitable hardware (e.g. transmitters, receivers, network interface controllers and the like) allowing processor 108 to communicate other devices, such as inertial measurement unit 116 and camera 120.

Furthermore in other embodiments, communications interface 112 may be connected to a network, the internet or other databases for information, allowing processor 108 to communicate with other computer devices, or other databases for information. This will be further discussed below. Specific components of communications interface 112 are selected based on the type of network or other links that processor 108 is required to communicate over.

System 100 can also include input devices that connect to processor 108, such as a keyboard and mouse, as well as output devices, such as a display. Alternatively, or in addition, the input and output devices may be connected to processor 108 via communications interface 112 via another computer device. In other words, input and output devices can be local to system 100 or remote.

In the current embodiment, inertial measurement unit 116 (also referred to herein as IMU 116) and camera 120 may be examples of input devices connected to processor 108 in system 100 via communications interface 112. IMU 116 may provide pitch and angle as an input to processor 108. Camera 120 may provide images as an input to processor 108. Other input devices (not shown) may also be used, such a wind sensor. A person skilled in the art will now recognize the availability of different input and output devices and that there are a variety of methods of connecting to processor 108.

In addition, in the current embodiment, IMU 116 and camera 120 may be separate components in a singular device with memory 104, processor 108 and communications interface 112. In other embodiments, IMU 116 and camera 120 may be separate devices external to a device with memory 104, processor 108 and communications interface 112. A person skilled in the art will now recognize the variations of input and output devices and their location with respect to memory 104, processor 108 and communications interface 112.

IMU 116 measures the pitch and angle of a slope on the putting green. In the current embodiment, IMU 116 comprises of an accelerometer, gyroscope and magnetometer, and may be built into system 100. IMU 116 is able to measure the magnitude of a slope upon which system 100 is placed. A person skilled in the art will recognize that IMU 116 may be any component or device that can measure pitch and angle of a surface. This includes, but is not limited to, an accelerometer, a gyroscope or a magnetometer, or other known device as well as any combination of the foregoing.

System 100 further includes camera 120. Camera 120 may be used to take images, which can then be analyzed to determine distance between two points. In the current embodiment, camera 120 may be used to determine the distance of the length of the putt. Furthermore, images analyzed from camera 120 may also be used to determine the magnitude of a slope of the green. A person skilled in the art will recognize that camera 120 may be a component or device that can aid in the determination of distance or the determination of the magnitude of a slope. For example, in alternate embodiments, camera 120 may be a device that utilizes LIDAR, a ranging device, a device that uses augmented reality, or other known distance or slope magnitude measuring device.

In the current embodiment, system 100 receives input data from an input device (e.g. a keyboard, touch screen, mouse, or the like), or input data from IMU 116, camera 120 or from external databases allows processor 108 to determine the read of a putt. The read of the putt may then be sent to an output device, such as a display.

Examples of input data include factors that are used to determine the read of a putt, including the pitch/angle/magnitude of slopes on the green, the length of the putt between the starting position and the target hole, and the green speed. IMU 116 may be used to obtain the pitch/angle of slopes on the green, and camera 120 may be used to obtain the length of the putt or the pitch/angle of slopes of the green. Other input devices, such as a wind sensor may also provide additional data to factor into the calculation. Alternatively, data that may be estimated, such as the green speed, or the length of the putt may also be input by a user through a graphical user interface through an input device. Other data that may be considered input data includes the position of system 100 when measuring the pitch/angle of slopes on the green, the “fall line”, the “maximum break line”, the “maximum break amount” (each of the foregoing would be understood by a person skilled in the relevant art), the x and y components of the slope magnitude, the optimal start direction, the optimal start pace, the length of a putt with a specific amount of break, the optimal start angle, the edge start distance, the effective target hole, the maximum break amount, the historical data of the golf course, the current weather, as weather patterns may affect green speed, and topological data of the golf course. The use of input data by processor 108 will be further discussed below.

A person skilled in the art will recognize the availability of different input and output devices, and there are a variety of methods of connecting to processor 108. It will also occur to a person skilled in the art that there are different configurations and different combinations of components to obtain the input data, and to process the input data. A person skilled in the art will also recognize that the input devices may also provide different data external from the slope, length of the putt or green speed, such as wind speed or other factors that may affect the trajectory of a ball, and that said data may be incorporated into the calculations above.

System 100 can be a computer device such as, but not limited to, a desktop computer, a laptop computer, a server, or a kiosk. In preferred embodiments, system 100 is a mobile device such as a smartphone, a cell phone or a tablet. A person skilled in the art will appreciate that other, different configurations of system 100 are contemplated. For example, in a preferred embodiment, system 100 combined with camera 120 and IMU 116 could be implemented as a tablet or a mobile device with built in input devices.

In alternate embodiments, memory 104, processor 108 and communications interface 112 may be part of a server, where communications interface 112 is connected to client devices, such as mobile devices. The mobile devices may include IMU 116 and camera 120. Input data may be collected on the mobile devices, either through an input device, IMU 116, or camera 120, and the input data may be sent to the server for processor 108 to determine the read of the putt. The read of the putt may then be sent back to the mobile device to be displayed.

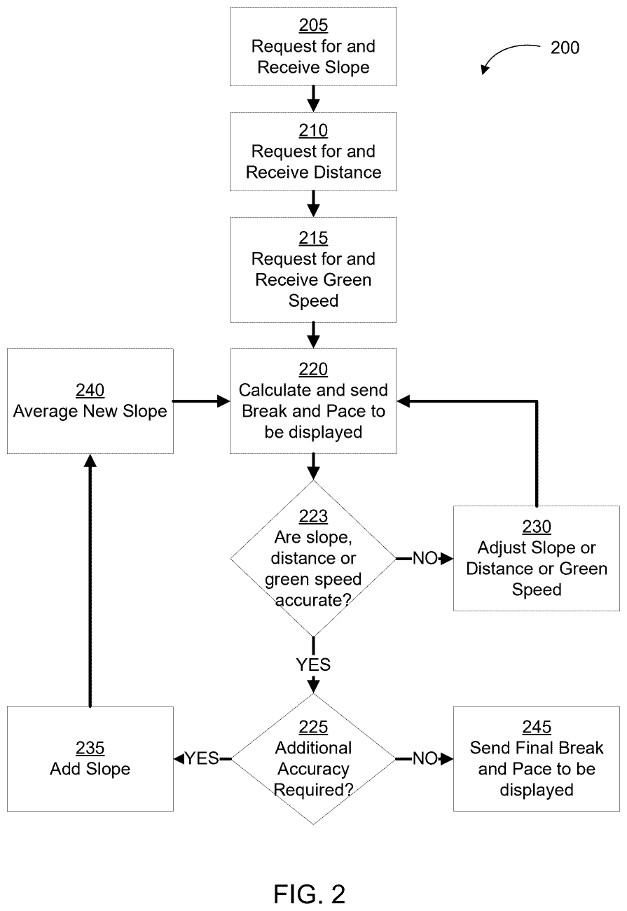

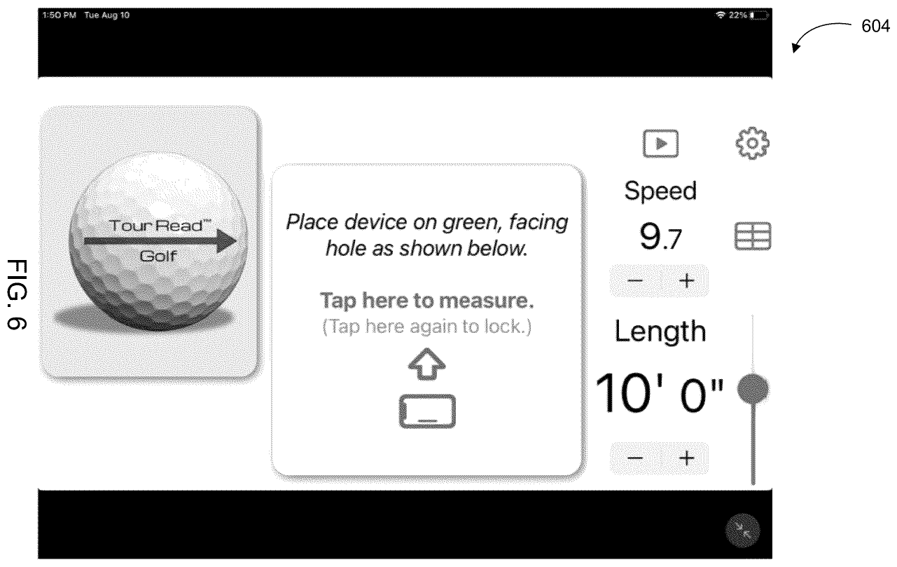

FIG. 2 depicts a method 200 of determining the read of a putt. Method 200 is initialized as soon as the user initiates the process of determine the read of a putt. In the current embodiment of system 100, where system 100 is a mobile device, the user would initiate the process through an application. Referring to FIG. 6, the graphical user interface of the application is shown as screenshot 604, where tapping the touch screen may initiate the process.

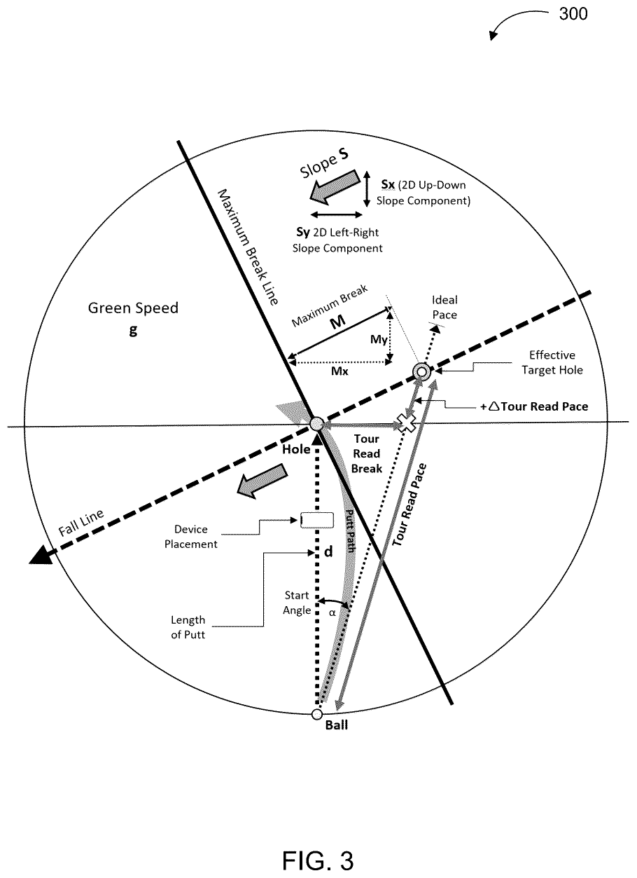

Block 205 depicts the request for and receival of the slope between the starting position of the ball on the putting green and the targeted hole. In the current embodiment, processor 108 requests a slope measurement from IMU 116 via communications interface 112. System 100, as a mobile device, is placed between the starting position of the ball (also referred to herein as starting position, or ball in FIGS. 3, 4 and 5) and the targeted hole, and a slope reading is taken by IMU 116. The slope reading is then sent from IMU 116 via communications interface 112 to be received by processor 108.

In alternate embodiments, block 205 may depict processor 108 further filtering and averaging readings from IMU 116 prior to receiving a final magnitude of slope from IMU 116. Filtering and averaging readings allows for erroneous slope readings to be filtered out and further allows for any movement in the device when the user interacts with the device that may affect the slope readings to be removed. For example, if the device is inadvertently moved, or if the device is interacted with by a user through a touch screen, the device may move. The movement may affect the slope readings, leading to erroneous data or readings. By removing any erroneous readings, the accuracy of the slope reading being received by processor 108 may be increased.

Furthermore, by adding additional filtering conditions, a more accurate slope reading may also be achieved. Filtering conditions may include ensuring that the device has been placed on a stationary position on a surface before taking readings. This will prevent any erroneous readings, or outlier readings if system 100 is moved while initiating the slope readings through interaction with the touch screen, or if the device is jostled, or if the position or orientation of the device is adjusted.

In the current embodiment, where system 100 is a mobile device a user may interact with the mobile device through a touch screen on a graphical user interface, IMU 116 may send continuous measurements to processor 108 to be displayed on the graphical user interface. This allows the user to observe the change in slope as they move the device to different areas of the putting green, preferably between the ball and the targeted hole. Once a user is satisfied with the placement of system 100, they may then indicate on the graphical user interface to lock a slope measurement in to be received by processor 108. The processor 108 then filters out the erroneous slope measurements.

In the preferred operation of the current embodiment, the user may initiate the continuous measurements and place system 100 on the putting green. The user may then observe the slope measurements on graphical user interface as IMU 116 sends continuous measurements to processor 108 to display on the graphical user interface.

The multiple slope measurements are analyzed by processor 108 to determine whether they meet a “stillness” threshold (e.g. the mobile device is found to be stationary). Readings/measurements that do not meet the stillness threshold are discarded, while readings that meet or surpass the stillness threshold are stored in memory 104. The stillness threshold may be determined by monitoring acceleration until the device is deemed or otherwise to be stationary. If the device is found to surpass the stillness threshold it will be considered to be stationary. In a preferred embodiment, slope measurements are taken into account or deemed accurate when the device is considered to be stationary. While the current embodiment may apply a stillness threshold to filter slope measurements where the device is not found or otherwise considered to be stationary, a person skilled in the art will recognize that other methods of discarding erroneous measurements are possible.

Erroneous slope measurements may continue to be discarded and slope measurements that surpass the stillness threshold may continue to be stored in memory 104 until the user locks in the slope. Once the slope measurements have stabilized (e.g. is considered stationary), the user may tap the screen (on a touch screen input device) to lock in the slope and indicate that the slope has stabilized, without further disturbing system 100, or further repositioning system 100. As tapping may destabilize IMU 116 and present erroneous readings, either the “last good” measurements or “next good” measurements are taken. This will be further discussed below. The tapping location on the graphical user interface is located centrally to minimize the effects of the tapping disturbing or affecting IMU 116.

If the memory 104 contains N or more slope readings that surpass the stillness threshold, the last N stored slope readings may be averaged and the resultant average may be used as the finalized slope measurement for calculating break and pace in the blocks to follow in method 200. N may be any integer where there is a sufficient confidence level that an averaged number of slope readings accurately depicts the actual slope of the putting green.

If memory 104 contains less than N slope readings that surpass the stillness threshold, processor 108 will continue receiving readings from IMU 116 until N slope readings that surpass the stillness threshold is reached. This will continue despite the user having tapped the touch screen to lock in a slope measurement. To ensure that this process is not endless, in the event that system 100 is moved, there is a time out period, after which an error may be displayed to the user on the graphical user interface.

The time out period is also used to prevent excessive batter usage by IMU 116. In the event that continuous slope measurements are received by processor 108 and the graphical user interface is waiting for a user to tap the touch screen to lock in the slope measurement, if there is no interaction from the user during the time out period, an error may be displayed to the user on the graphical user interface, and IMU 116 will stop taking slope measurements.

The request and receipt of the magnitude of the slope is not limited to using IMU 116. The magnitude of the slope may also be entered manually, either through user estimation of the slope, or through the manual measurement of the slope using a level, or other apparatuses. A person skilled in the art will realize that the determination of the slope for processor 108 may be obtained through various methods and is not limited to IMU 116. A person skilled in the art will also recognize that there are various ways of obtaining a more accurate slope reading while analyzing the data and filtering or discarding outlier data.

Furthermore, to ensure the accuracy of the slope data, a calibration application (as will be described below) may be used to calibrate IMU 116 and system 100.

Typically, the preferred location for obtaining a slope reading is located anywhere in the second half of the straight line distance between the starting position and the targeted hole. ⅔^{rd} of the straight line distance between the starting position and the targeted hole is recommended or preferred for most users because it is both easy to visualize and will typically give a representative slope measurement. For example, if the starting position were 3 ft from the targeted hole, then a typical recommended device placement of system 100 would be 2 ft from the starting position, and 1 ft from the targeted hole (⅔rds of the way). Other positions between the ball and the hole often will have similar slope.

While the preferred location for obtaining a slope reading is ⅔rd of the straight line distance between the starting position and the targeted hole, the slope reading may be taken anywhere between the starting position and the targeted hole, as depicted by the dotted line labelled length of putt in FIG. 3. ⅔rd of the distance is considered to be the preferred device placement of system 100 as it produces the most accurate results when taking into consideration the depletion of velocity of a ball over its trajectory, and a slope's effect on the ball as it closes on the targeted hole. A person skilled in the art will understand, however, that any position may be useful under specific conditions of golf play.

The orientation of system 100 when placed on slope may either be in portrait or landscape. In the current embodiment, where system 100 is a mobile device, a landscape orientation is preferred. A landscape orientation is advantageous as determining the left-right break of the slope is of primary interest, as this places more of the surface area of the mobile device in the relevant plane, and will give a more accurate reading of the slope.

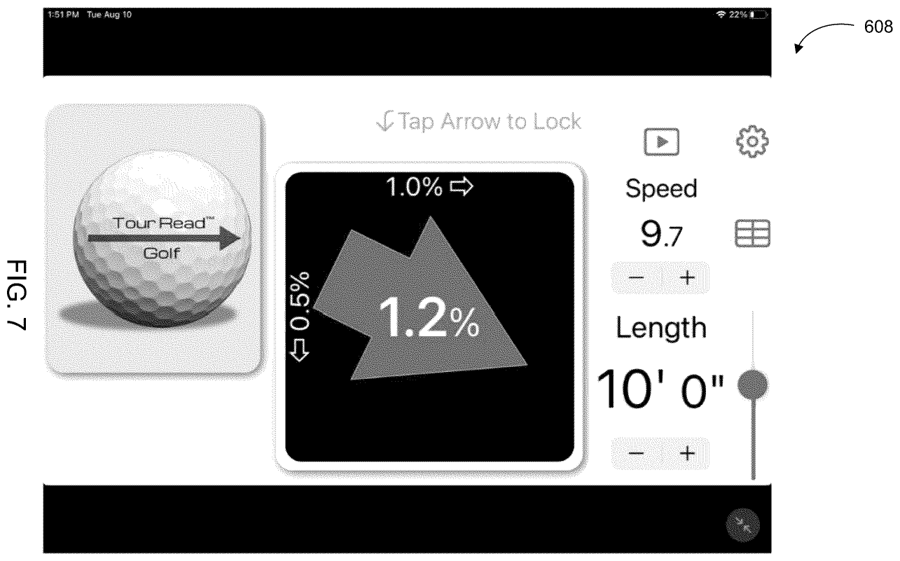

FIG. 7 shows an example graphical user interface as screenshot 608 where the slope reading is taken. The reading may be taken when the user places system 100 on the ground to measure the slope. In the current embodiment, there is a −0.5% grade along a first axis (e.g. the vertical or y-axis), and a 1.0% grade along a second axis (e.g. the horizontal or x-axis), leading to a 1.2% grade in the direction indicated on the graphical user interface. Typically on putting greens, slopes do not exceed 4% on either the first or second axes when measured in areas proximate to the hole.

In alternate embodiments, the slope may also be determined based on topological data that is requested and received from external databases. Once topographical data on a golf course has been received, processor 108 may determine the slope based on the starting position and the targeted hole.

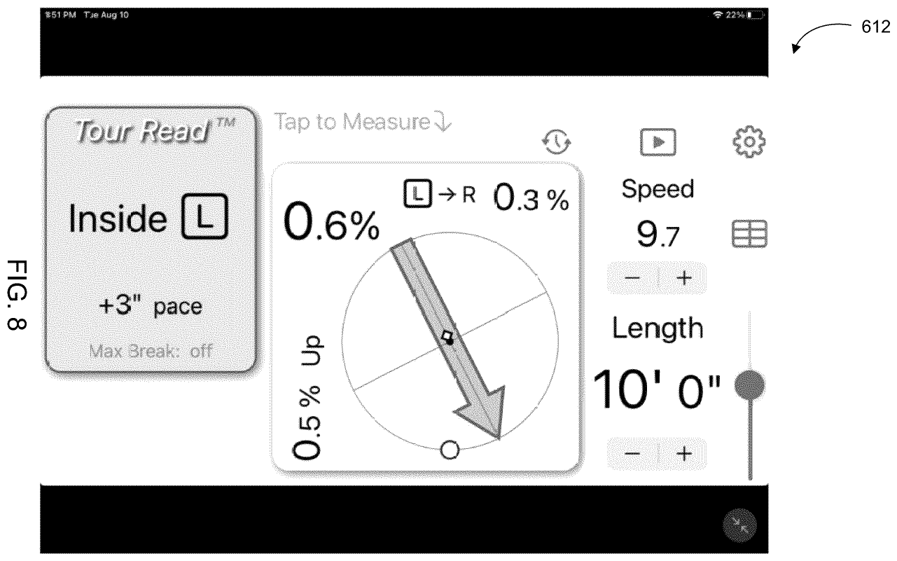

Returning to FIG. 2, block 210 depicts the request for and the receival of the length of the putt (also referred to in FIG. 2 as distance). The length of the putt may also be referred to as the straight line distance between the starting position (centre of the ball) and the centre of the targeted hole. An example of the length of the putt may be seen in FIG. 3. In the current embodiment, processor 108 may request for the length of the putt from the user through the graphical user interface. The length of the putt is entered manually through the graphical user interface. As can be seen in FIG. 8 in screenshot 612, the is set to 10 ft.

In alternate embodiments, camera 120 may be used to measure the length of the putt. Processor 108 may send a request for the length of the putt to camera 120 through communications interface 112. Camera 120 may take a photograph, and send the photograph back to processor 108. Processor 108 may then use image analysis to determine the distance between the starting position and the targeted hole.

In alternate embodiments, processor 108 may be connected to external databases via communications interface 112 to gather data regarding the length of the putt. Topographical data on a golf course or other data regarding the golf course may be requested by processor 108 through communications 112 to external databases. Once topographical data on the golf course or other data has been received, the distance for the length of the putt may be determined.

Returning to FIG. 2, block 215 depicts the request for and the receival of the green speed. As indicated previously, the green speed is primarily a measure of the amount of friction that affects the rolling golf ball, and is affected by many different factors, including, but not limited to, the type of grass, the length of the grass, the direction of the grass, the moisture content of the grass, what time of day it is, and when the grass was last cut or rolled. Golf course operators do not generally publish or even measure green speeds, though this information may be available at professional or top amateur tournaments. Even if it is provided the green speed can significantly change over the course of a day based on a number of factors including weather, temperature, watering, time of day, time since last cut or rolling, players walking on the grass, etc. Typically green speed may range between 8.5 to 12.5, where 8.5 is considered a slow green, and 12.5 is the green speed for a US Open golf tournament.

In the current embodiment, processor 108 may sent a request to the user for the input of the green speed. The user can then estimate and provide the green speed through a graphical user interface. As can be seen in FIG. 8 in screenshot 612, the green speed has been set to 9.7 through an input device. Processor 108 may then receive the green speed via communications interface 112.

It will be understood by a person skilled in the art that the order in which the slope, distance and green speed are determined, requested or received is not limited to method 200, in which the slope is requested, determined and received first, the distance is requested, determined and received second, and the green speed is requested, determined and received third. The slope, distance and green speed may be requested and received in any order.

Once the slope, distance and green speed have been received by processor 108, the break and pace may then be determined as depicted at block 220. The break is defined as the target distance left or right of the targeted hole along a line that is perpendicular to the direct ball-hole line. As an example, referring to FIG. 3, a user at the starting point will be aware that the hole is directly in front of them. However, given the slope, the user will have to hit the ball towards the right (as provided in FIG. 3) in order to reach the targeted hole. The break is the distance amount and direction that a user may aim for in order for the ball to reach the targeted hole. For example, a user may need to aim to the right by 2.7 inches in order for the ball to reach the hole.

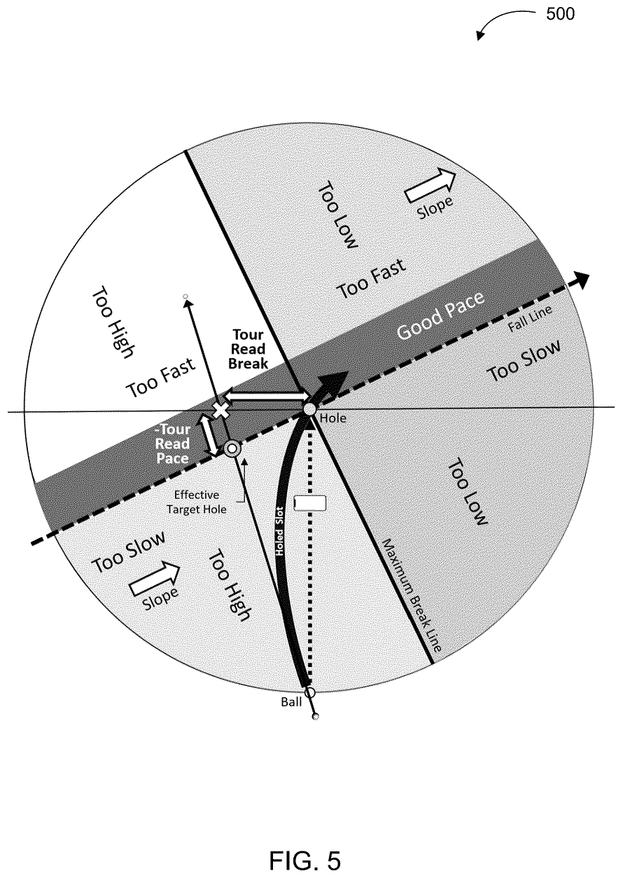

The pace is defined as the amount of distance that a user needs to shoot for in order for the ball to reach the targeted hole. For example, in FIG. 3, there is a slope directed towards the left (e.g. the slope is generally higher on the right side of FIG. 3 and slopes downwards from the right side towards the left side of FIG. 3), and back towards the starting position (e.g. the slope is generally higher on the top portion of FIG. 3 and slopes downwards from the top side towards the bottom portion of FIG. 3). As such, to compensate for this slope, the pace will need to be further than what the targeted hole is. As an example, the pace may be +3 inches. To a user, this will mean that they will have to hit the ball as if the hole was 3 inches further than what is measured. Alternatively, as depicted in FIG. 5, if the slope is falls away and to the right of the starting position (e.g. the opposite of the slope in FIG. 3), then the pace may be −3 inches. To a user this will mean that they will have to hit the ball as if the hole was 3 inches closer than what is expected in order to reach the targeted hole. In both FIG. 3 and FIG. 5 the dashed fall line indicates the downward direction of the slope.

The combination of break and pace allows a user to aim for an effective target hole, effectively providing the user with a read of a putt. By aiming for the effective target hole, the ball will ideally reach the targeted hole due to the slope.

The break and pace may be calculated by breaking down the slope measurement into their respective X and Y components. Once the X and Y components are available, the X and Y components of the maximum break line (as shown in FIG. 3) can be determined, while taking into consideration the green speed, the length of the putt and the ratio of the distance from the starting position that the slope measurement was taken to the distance from the targeted hole (i.e. ⅔). With the X and Y components of the maximum break line, the break and the pace may be determined as well.

The physics for calculating the path of a putt along a green is well established. These can be found in Vector Putting: The Art and Science of Reading Greens and Computing Break (H. A. Templeton 1984), The Physics of Putting (Albert Raymond Penner—Vancouver Island University, 2002), Canadian Journal of Physics 80 (2): 83-96 and The Geometry of Putting on a Planar Surface (Robert D. Grober-Yale University, 2011), all of which are incorporated by reference.

In the current embodiment, the calculations to determine break and pace are simplified.

Once the Slope(S) of the putt, the Length of Putt (d) and the Green Speed (g) have been determined, within the range of slopes where a hole can reasonably be expected to be located (0 to 4%) and actual green speeds (7.5 to 13.5), the physics simplifies to a linear equation:

The calculations used are based on first calculating the Maximum Break (M) (in inches) for a given Slope(S) (as a %), Green Speed (g) (in feet) and Length of Putt (d) (in feet) as measured directly from the ball to the pin.

$$M = k 1 * S ⋆ g * ( ( k 2 ⋆ d ) + k 3 )$$

k1, k2 and k3 are constants. The values of k1, k2 and k3 are determined by the assumptions made about the starting conditions and how the golfer defines ideal pace.

Buffer conditions may also be considered, where an assumption is made that the user may wish to hit putts with an initial velocity that would leave the ball 12″ past the hole. The buffer condition accounts for the speed and the strength that a user may hit the ball with. While any buffer condition may be used, a buffer condition between 8″ and 16″ past the hole is preferred and considered as the ideal pace. The ideal pace is preferred as it maximizes the chances of the ball going into the targeted hole and at the same time minimizes the chances of missing a subsequent putt. The ideal pace may also vary depending on the conditions of the green, such as how bumpy the greens are.

The buffer condition may be changed by the user. For example, users may adjust the buffer condition if they prefer to hit putts at “dead weight” where the ball just gets to the hole. Alternatively, users may prefer to hit putts at “ram speed” where they are hitting the putt at a higher speed to ram the ball in the hole and minimize any imperfections in the green. A buffer condition with an ideal pace is between a “dead weigh” putt and a “ram speed” putt. In alternate embodiments, system 100 may also provide the optimal buffer conditions to match a specific amount of break and also provide different paces for putts depending on where the putt is aimed. For example, different paces may be provided depending if the putt is aimed at the inside right edge as opposed to the outside right edge.

Based on a buffer condition of 12″ (e.g. the ball would be estimated to travel an extra 12″), the k1, k2 and k3 constants are k1=0.1, k2=0.667 and k3=−1.0. The constants were derived by charting the amount of expected break for a combination of known magnitudes of slope, greed speeds and lengths of putt. The constants were then verified and refined through testing on the putting green and in lab testing.

It will be understood by a person skilled in the art that different buffer conditions will provide different values for constants k1, k2 and k3.

The Maximum Break (M) is calculated using the x component of Maximum Break (Mx) and the y component of Maximum Break (My), which are proportional to the Slope(S), the x component of Slope (Sx) and the y component of Slope (Sy) and can be calculated using ratios.

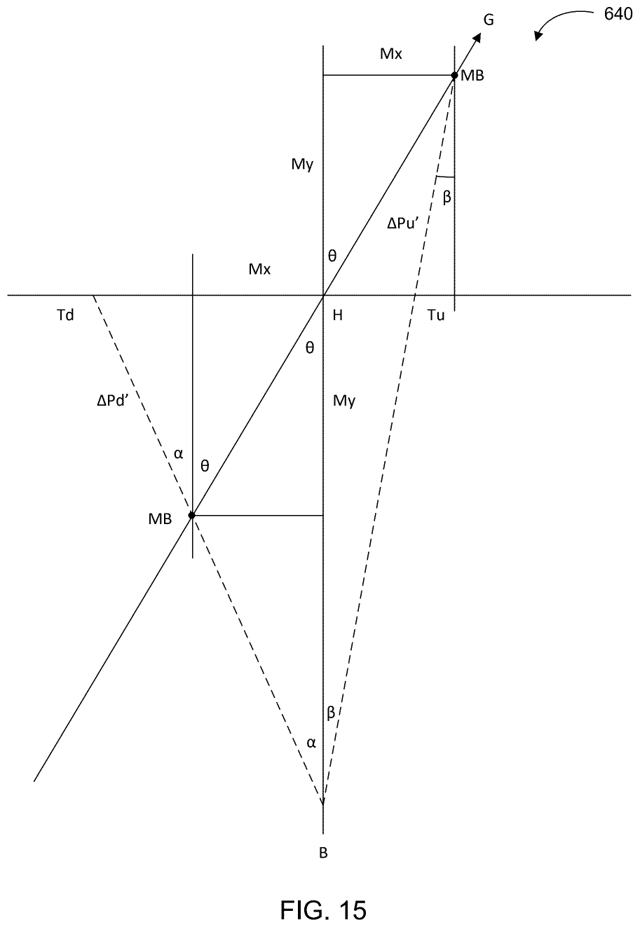

As shown in FIG. 3 and in FIG. 15, for example, the X and y components of the variables (e.g. M) are calculated using a frame of reference where the y direction is a straight line from the ball to the targeted hole and the x direction is perpendicular to the straight line between the ball and the targeted hole.

As previously mentioned, the read of a putt has both a break and a pace.

The break is the x component of Maximum Break (Mx).

Referring to FIG. 15, in the current example, an uphill putt is depicted towards the right of the vertical or y-axis, and a downhill putt is depicted towards the left of the vertical or y-axis. For either the uphill putt or downhill putt, the maximum break along the x component (Mx) and the maximum break along the y component (My) may be calculated as follows:

$$Mx = MB \times sin θ$$

$$My = MB \times cos θ$$

The pace and Δpace (as indicated as Δp in FIG. 15) are then calculated using standard trigonometry as detailed in FIG. 15.

The pace and Δpace may be calculated as follows:

$$P = \overline{B \times MB}$$

$$Δ P = P - \overline{B \times H}$$

$$Δ {Pu}^{′} = \overline{Tu \times MB}$$

$$Δ {Pd}^{′} = \overline{Td \times MB}$$

The break will be smaller for uphill putts and larger for downhill putts.

In the current embodiment as depicted in FIG. 15, the calculations for the uphill putt are as follows:

$$D = \overline{B \times H}$$

Where β, the desired start angle for the uphill putt, can be calculated by:

$$tan β = \frac{Mx}{D + My}$$

Where ΔPu′ is the Δpace for the uphill putt, and can be calculated by:

$$Δ {Pu}^{′} = \overline{MB \times Tu}$$

$$cos β = \frac{My}{Δ {Pu}^{′}}$$

$$Δ {Pu}^{′} = \frac{My}{cos β}$$

In the current embodiment as depicted in FIG. 15, the calculations for the downhill putt are as follows:

$$D = \overline{B \times H}$$

Where α, the desired start angle for the downhill putt, can be calculated by:

$$tan α = \frac{Mx}{D - My}$$

Where ΔPd′ is the Δpace for the downhill putt, and can be calculated by:

$$Δ P {d}^{′} = \overline{MB \times Td}$$

$$cos α = \frac{My}{Δ {Pd}^{′}}$$

$$Δ {Pd}^{′} = \frac{My}{cos α}$$

In an alternative embodiment, a read of a putt may also be displayed with a start angle and a start angle distance. The start angle and start angle distance may further aid a user in understanding the trajectory of a putt and may provide alternative displays for users to understand the read of a putt.

As shown in FIG. 3 and in FIG. 15, the Start Angle α (downhill putt) or the Start Angle β (uphill putt) is the angle between the direct line from the ball to hole and the initial target direction that a putt should be struck allowing for the calculated break. Most putts have a very small start angle (between 0 to 2 degrees), and as such may be difficult for a user to adjust to when hitting a ball.

Start Angle Distance is defined as the distance that you would have to be from the hole such that the Start Angle allows for a break of 2.125″ which corresponds to the radius of a standard hole. This allows the golfer to visualize what the correct start angle looks like by visualizing a ball this distance from the hole. This visual can then be translated to any length of putt.

Being able to visualize Start Angle using Start Angle Distance is useful because putts of all distances on the same slope and green conditions can be successfully holed using the same Start Angle for the putt.

Once calculated, the break and pace are then displayed on a graphical user interface in screenshot 612, as can be seen in FIG. 8. A visual interpretation of the read of the putt is also presented to the user. Break and pace can be displayed in various ways.

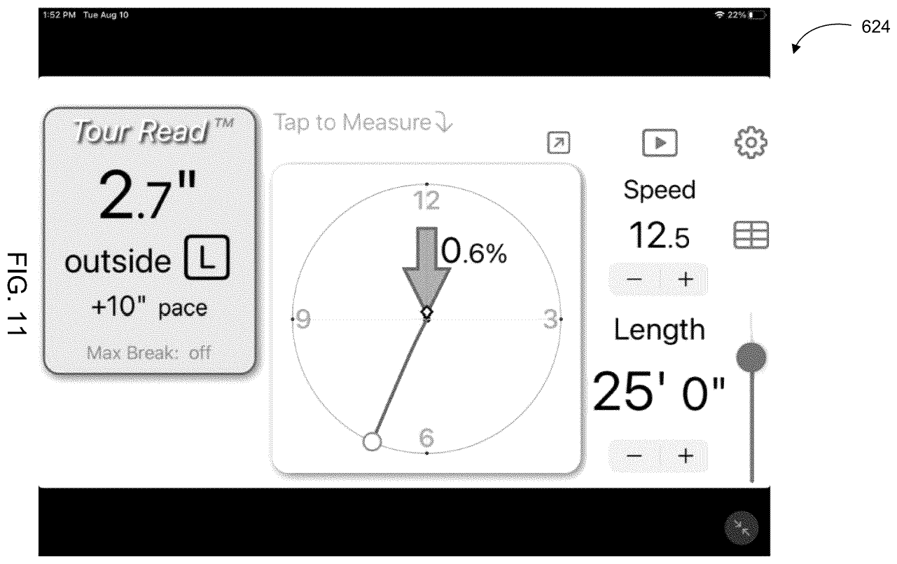

Referring to FIG. 11 at screenshot 624, in an alternative embodiment, the read of the putt may also be displayed on the graphical user interface using a visualized clock model. The visual clock model depicts a break determined from a single or plurality of measurements to determine the break of any putt of varying length or orientation. This allows for a plurality of reads around the clock, and distances. As shown in FIG. 11, the downward slope of the green, as measured, may be illustrated by the downward arrow. The ball may be placed at the 7 mark on the clock face, and the target hole may be represented by the center of the clock face. In the current example, a user may aim the ball toward the middle of the clock face to hit the target hole based on the measured slope with the approximated speed and length of putt.

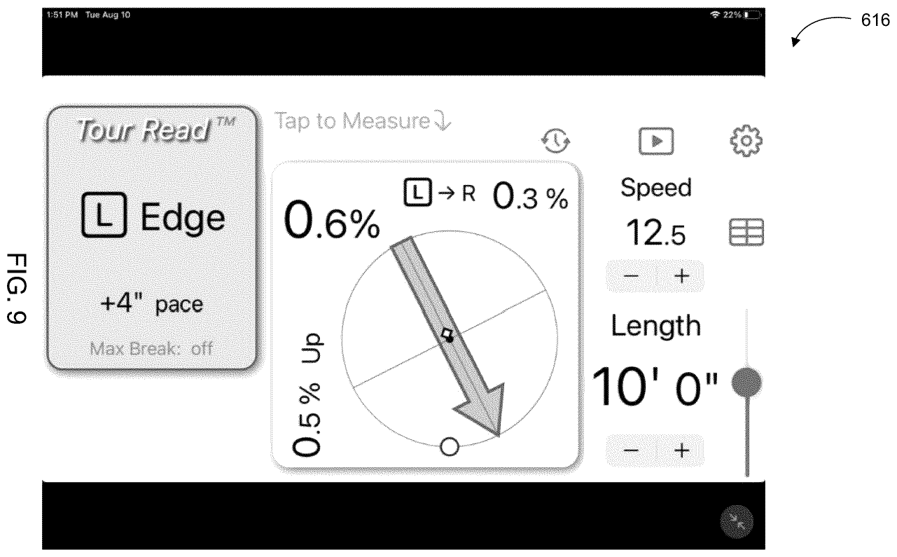

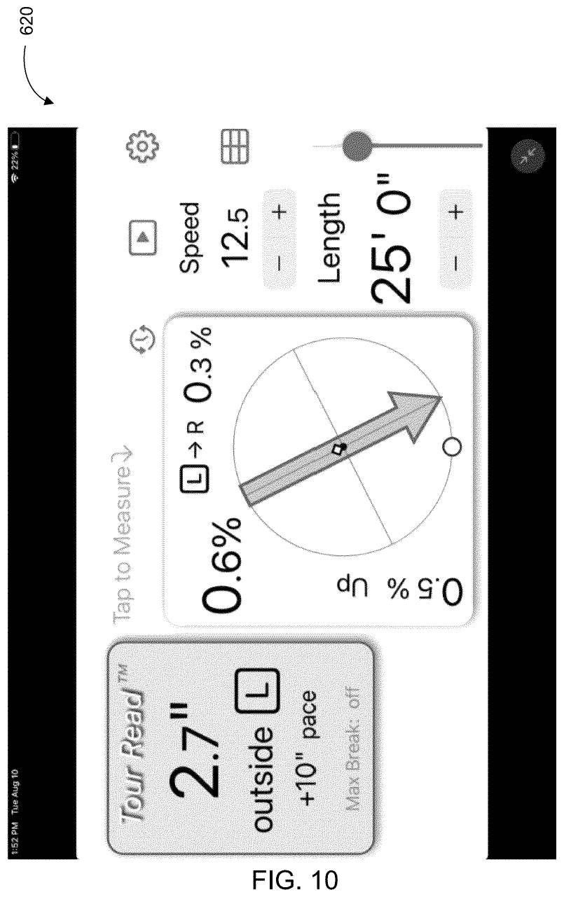

Returning to FIG. 2, at block 223, the slope, distance or green speed may be analyzed to determine if they are accurate. This may be determined by the user based on their knowledge of the course, past experience and the green conditions in the measurement spot. A user may also adjust the position of system 100 slightly (to another location in close proximity, but on a similar slope) to take a second reading to confirm the accuracy of the reading. If the existing slope, distance or green speed are inaccurate, they may be adjusted as depicted at block 230. The user may make said adjustments via the graphical user interface. As an example, FIG. 9 depicts screenshot 616, where the green speed is changed to 12.5 from the originally entered green speed of 9.7 as depicted in FIG. 8 at screenshot 612. In another example, screenshot 620 of FIG. 10 depicts the length of the putt being changed to 25 ft from the originally entered 10 ft as depicted in FIG. 8 as screenshot 612. In both of these examples, the values can be changed either via the “+” and “−” buttons, sliders, or can be entered as text. The existing slope can also be measured again using IMU 116. In alternate embodiments, if camera 120 may also be used to measure distance again. It will be understood by the person skilled in the art that adjustments to slope, distance or green speed variables are not limited to manual adjustment via a graphical user interface, but may be obtained via other means, such as the means that were used to obtain the values in blocks 205, 210 and 215.

Once a new slope, distance or green speed has been received by processor 108, method 200 returns to block 220, where the break and pace are calculated again, and displayed on the graphical user interface.

Returning to block 223, If the slope, distance or green speed are accurate, the precision of the slope may be analyzed at block 225. For example, if there are multiple bumps or inclines between the starting position and the targeted hole, additional slope measurements may be taken, as is depicted in block 235.

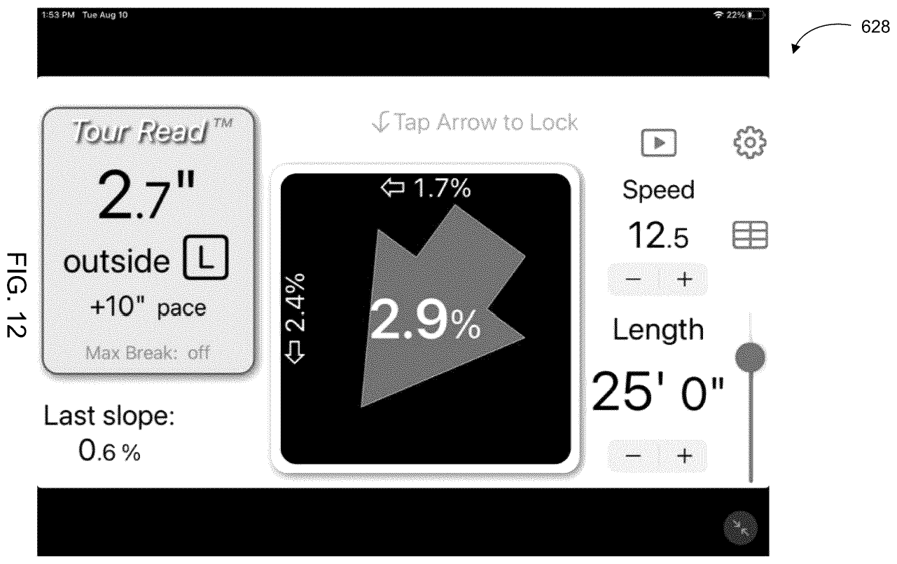

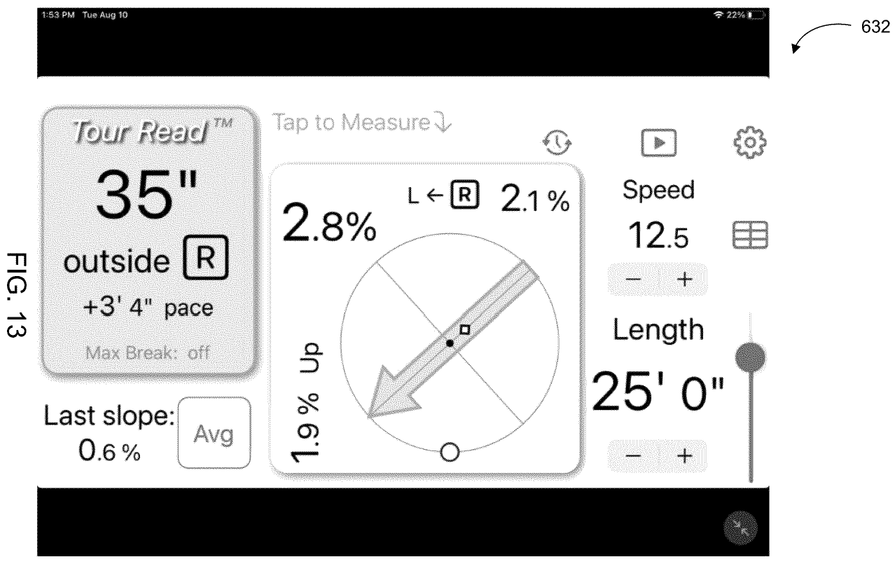

FIG. 12 depicts the addition of a new slope as shown in screenshot 628. As can be seen, a slope of −2.4% on the y axis, and −1.7% on the x axis, resulting in a 2.9% slope downwards and to the left is measured. Once the slope has been measured, a new break and pace is provided, as can be seen in screenshot 632 of FIG. 13.

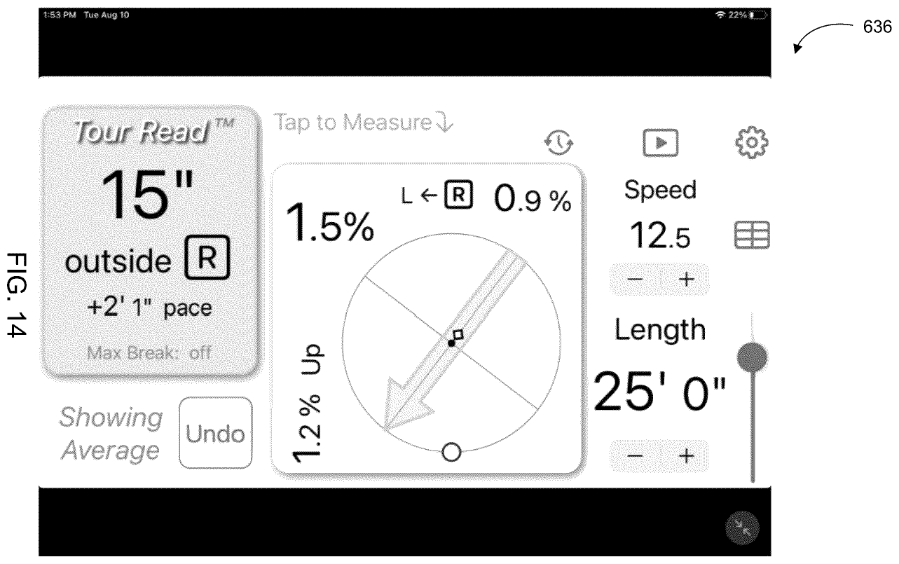

Users are then provided with the option of averaging the previous slope with the new slope at block 240. The addition of a new slope may be a weighted average and may also take into consideration the positioning of the slope measurements along the straight line distance between the starting position and the targeted hole. FIG. 14 depicts screenshot 636, the graphical user interface once a second slope has been averaged, and the break and pace re-calculated and displayed, as depicted at block 220. A person skilled in the art will recognize that the addition of slope measurements and averaging the slopes is not limited to only a second slope, but may include multiple slope measurements.

Returning to FIG. 2, at block 225, if no more adjustments are required, such as if the average slope provided is precise enough, or if the slope itself is a single constant gradient with no change, then the final calculated break and pace and/or read of the putt may be displayed on the graphical user interface at block 245, to aid the user in hitting the ball into the targeted hole.

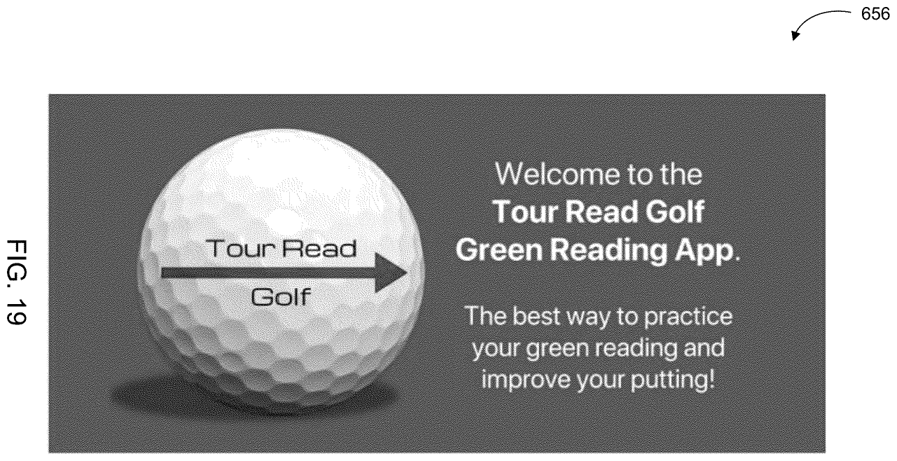

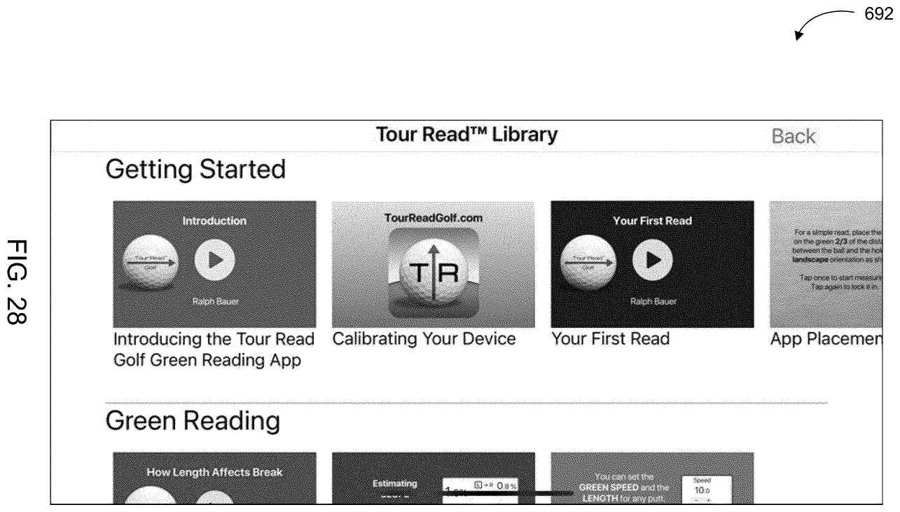

Referring to FIG. 28, screenshot 692 shows an example media library for displaying help and training information via images, video, links and other formats. Method 200 is similarly provided in a series of screenshots or a graphical user interface accessible via the media library for the user to understand the process. For example, a user may select “Introducing the Tour Read Golf Green Reading App”, and will be provided with screenshot 656 in FIG. 19 as the initial page, where screenshot 656 is welcoming the user to the application.

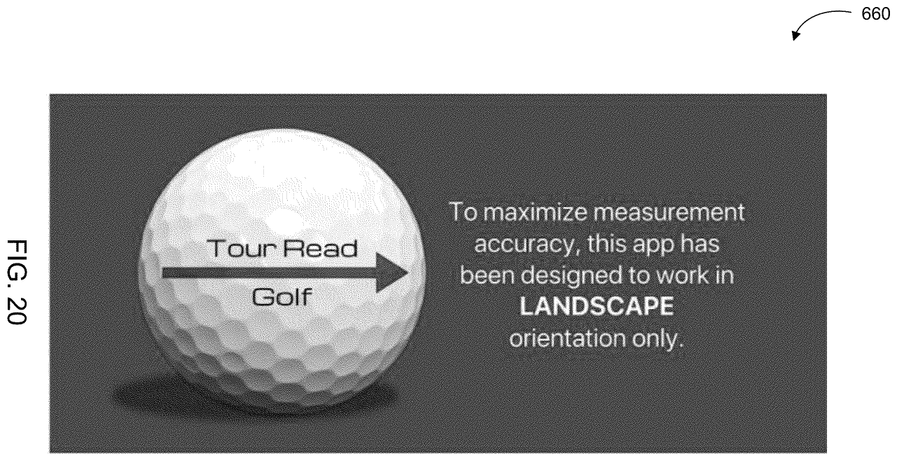

FIG. 20 provides screenshot 660 which indicates to the user that the application works in landscape mode to maximize measurement accuracy. However, in other embodiments, a portrait mode may be used as well, and the accuracy of measurements may also depend on the orientation of the input devices, including the orientation of IMU 116 or the orientation of camera 120. A person skilled in the art will recognize that an application is not limited to a specific orientation on a display, and that the corresponding input or output devices are not limited to specific orientations.

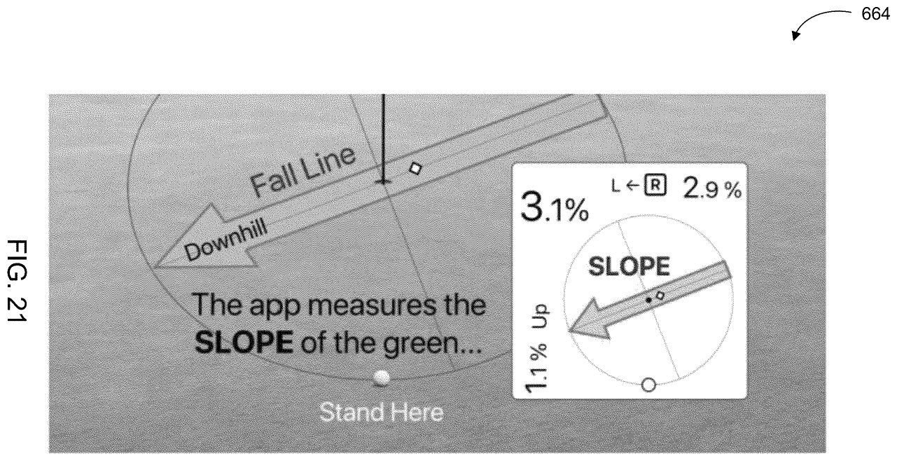

FIG. 21 provides screenshot 664 which shows a user how to obtain an accurate measurement of a slope of a green. Specifically, screenshot 664 depicts for a user the measurement of the slope on a green, the placement on the phone to measure said slope, and what the display will portray from measuring said slope.

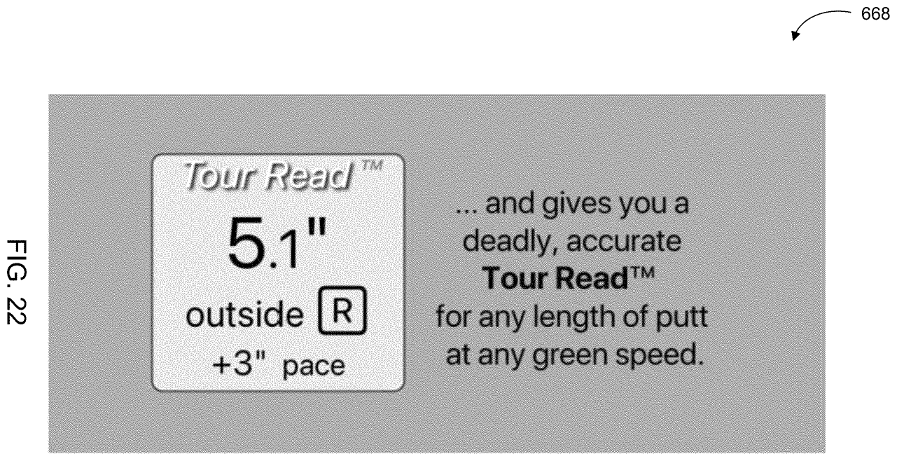

FIG. 22 provides screenshot 668 which shows a user the resultant read of a putt based on the measurement of the slopes and other factors for any length of putt at any green speed.

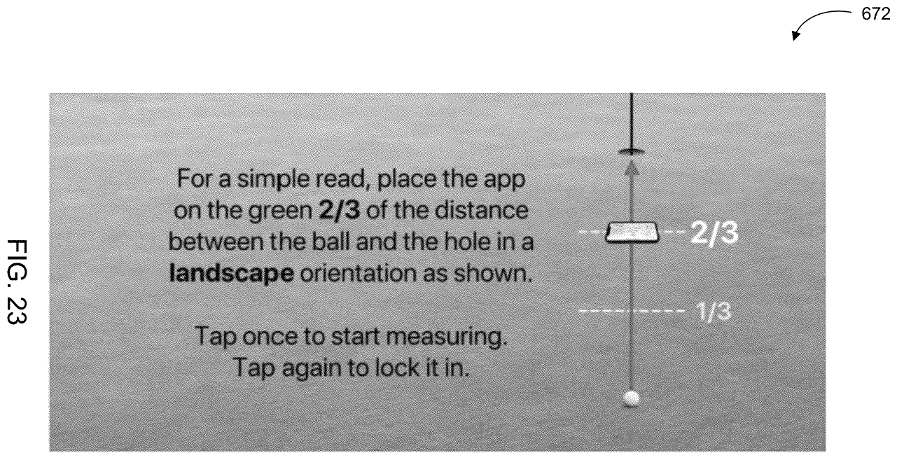

FIG. 23 provides screenshot 672 which shows a user the preferred location of the mobile device when measuring the slope given the distance between the starting point (e.g the location of the ball) and the target location, namely the hole. In the current embodiment, screenshot 672 is showing that the preferred location for measuring the slope is ⅔^{rd} of the distance between the starting point and the target location. Screenshot 672 is further providing instructions that the preferred orientation of the mobile device when measuring slope is in landscape orientation that is normal to the trajectory of line between the starting point and the target location. Furthermore, screenshot 672 is providing instructions on interacting with the display to start the measurement, and to lock the measurement in. A person skilled in the art will recognize that there may be a variety of different locations and orientations for system 100 to obtain a slope measurement. Furthermore, a person skilled in the art will recognize that there may be different methods of interacting with the display and the graphical user interface to obtain a measurement, including different methods that may or may not include interactions with the graphical user interface to begin slope measurements, or to lock a slope measurement to be used.

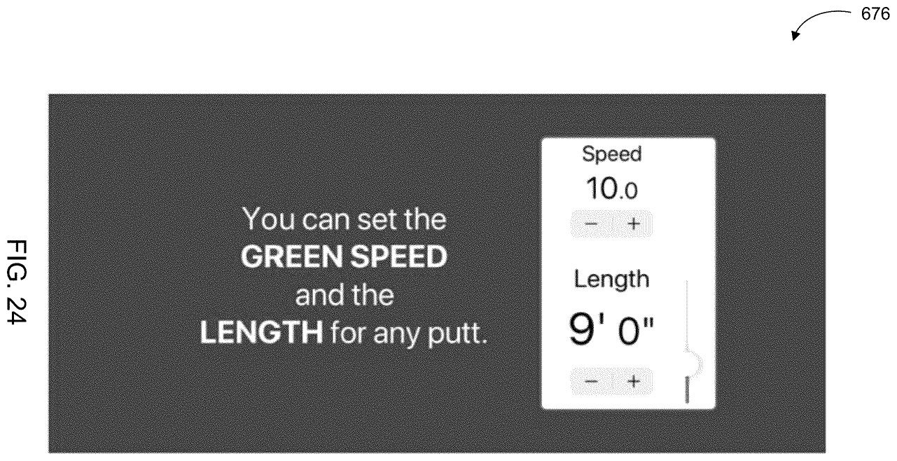

FIG. 24 provides screenshot 676 which indicates to a user the ability to change the green speed and the length of any putt on the graphical user interface. In the current embodiment, this may be adjusted via the “+” and “−” buttons, or through a slider, however a person skilled in the art will recognize that there are various interactive elements, tools or methods of adjusting a green speed or a length of a putt through a graphical user interface.

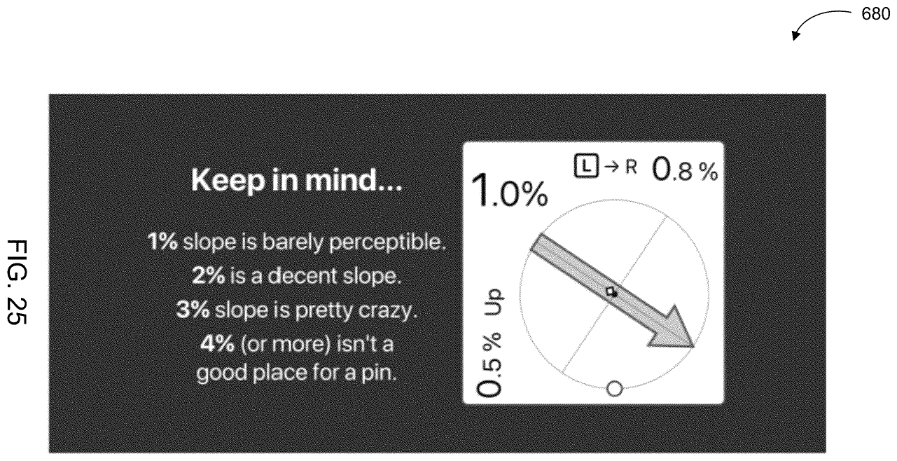

FIG. 25 provides screenshot 680 which indicates to a user the approximate slope values that a user may perceive in relation to the slope values that are measured using system 100.

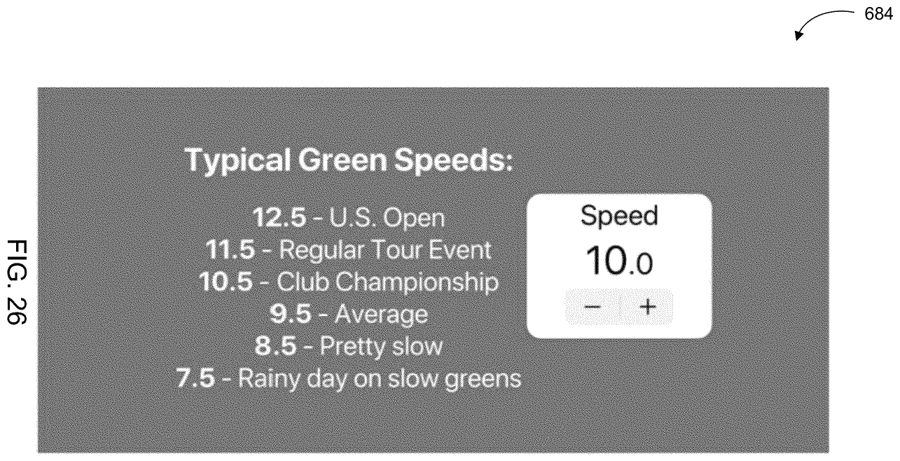

FIG. 26 provides screenshot 684 which provides to the user typical and approximated green speeds for different types of courses and different weather conditions.

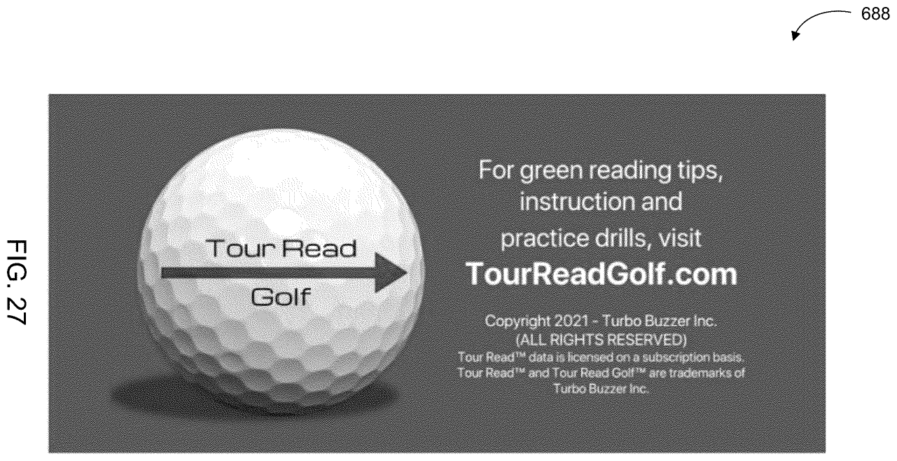

FIG. 27 provides screenshot 688 which provides an example link or contact page to obtain more information in relation to the application for system 100.

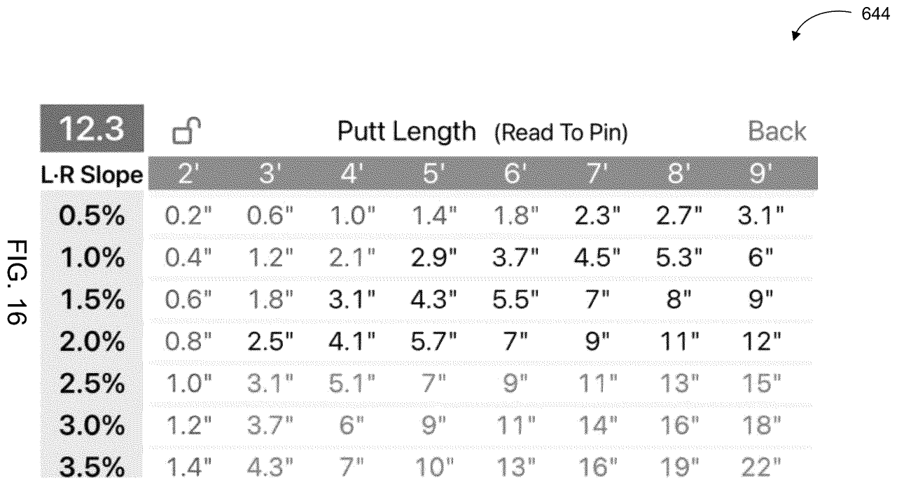

Referring to screenshot 644 in FIG. 16, system 100 may further provide charts to be used to display the estimated break for a plurality of slopes and lengths of putt. The green speed (g) may be entered via the graphical user interface, and based on a plurality of slopes along the left hand column and lengths of putt along the top row, the user can then determine the estimated break required. Break amounts may be shown in green, or red. Break amounts in green in this view represent putts that should be aimed inside the outer edge of the hole and are less than 2.125″. Break amounts in red represent putts where the Slope*Green Speed product is greater than 30. These putts are considered to have “runaway potential” and golfers should be wary of these putts because the ball may not stop near the hole. Golfers may wish to allow more break than is shown on the chart in these cases.

In screenshot 644 of FIG. 16, the green speed is set to 12.3, and various breaks are provided based on the magnitudes of slope and the length of putt. For example, a 6′ putt on a 2.5% slope would yield an estimated break of 9″.

The values for break on the chart make the assumption that putts are neither uphill nor downhill, and only have a left-right break component. This further simplifies the read, as only the x component of the Slope (Sx) is estimated and referred to along the left hand column. As such, users using the chart may need to compensate by providing less break for uphill putts and more break for downhill putts. If users are estimating break using the slope of the fall line, this compensation is not be needed.

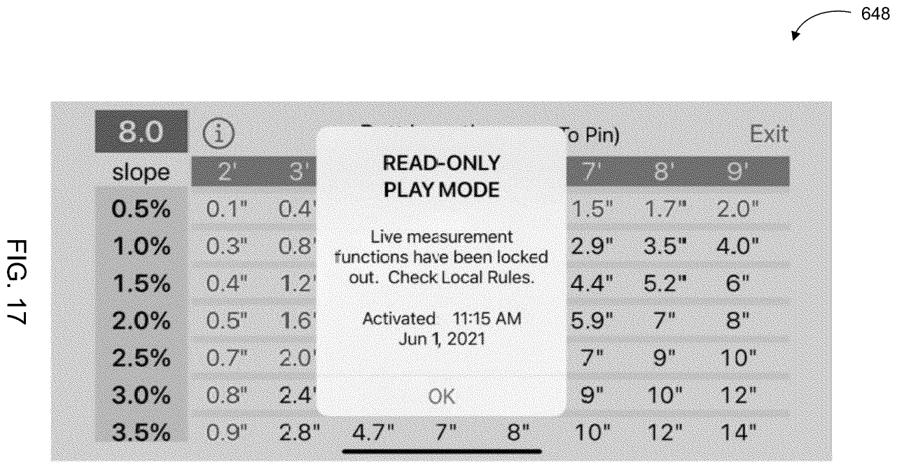

During golf tournaments, or under certain conditions, golfers may not be allowed to use a device to measure the slope of the green. As such, the charts allow for values that user may consult, based on manual input values that are estimated by the golfer/user. Using this chart is considered legal for play under most tournament guidelines. In certain embodiments, the slope measurement function of system 100 may be locked out from users and logged to provide evidence that measurements are not being taken, and that only the chart is being used. FIG. 17 depicts the graphical user interface as screenshot 648, which displays the warning once this mode is activated. As can be seen in the warning, a time and date is logged of when the mode is activated.

System 100 may also be used as a training tool for golfers to increase their ability to estimate the slope, length of a putt and green speed, and the resultant break and pace of a putt. This is important, as in certain golf tournaments, electronic aids or devices may not be permitted. As such, it is important for a golfer to be able to estimate the magnitude of a slope, or the green speed.

For example, if a golfer (or user) wished to increase their accuracy with respect to estimating the green speed, they can setup a putt with known values and variables for the slope and the length of a putt, and provide an estimated green speed. The user can then hit the golf ball along the known trajectory and mark the trajectory using chalk lines or string lines. If the ball goes into the targeted hole, then the green speed that was estimated was correct. If the ball does not reach the targeted hole, or overshoots the targeted hole, then the green speed may be readjusted. For example, with a putt of approximately 10′ length on a 3% slope putting along the maximum break line (perpendicular to the fall line) may be used. 10′ at a slope of 3% with green speed of 10 will break 15″ if the player is putting along the maximum break line. The spot on the green as indicated by the break in system 100 may be marked using chalk lines or string lines. A putting gate or tees may be placed near the ball to ensure the putt is along the correct starting line. By hitting several putts along the correct line, the actual break can be compared to the break provided by system 100, and the green speed can be adjusted until the actual break matches the break provided by system 100.

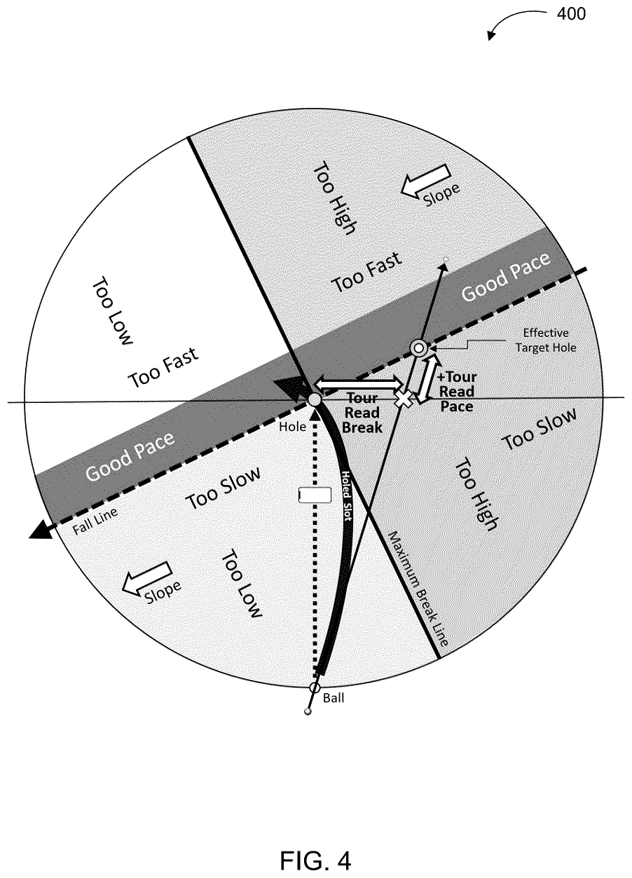

Similarly, training the pace with a golfer may also be accomplished with assistance from system 100. After using system 100 to take a read of a putt, the user/golfer may hit the ball along the proposed read. If the location of the ball finished short of the fall line, the pace may be deemed to be too slow. If the location of the ball finished beyond the fixed distance for good pace, then the pace may be too fast. FIGS. 4 and 5 depict the example areas where pace may be deemed to be too low, too fast, or where there is good pace.

The consistency of a golfer may also be trained by repeating the same putt based on the same read of a putt, and determining where the ball ends up. Repeating putts of varying lengths of putt with known variables (such as the green speed and the magnitude of slope) as provided by system 100 will help develop the consistency with which a golfer can strike a putt at the optimal pace. This is important to the training of golfers, and may be difficult without system 100 or method 200.

Pace can also be trained and refined based on a user's preferences. With a known read, users can adjust the buffer conditions and pace to further train themselves.

Other forms of training with the assistance of system 100 may be contemplated and are provided below:

Model #1: For a player to train the skill of accurately estimating the slope of a green without actually stroking putts:

It is important to detect small variations in the slope, as they affect the break and pace of the ball, but is difficult for users to properly estimate without the aid of system 100. Top professional golfers may have an increased ability to estimate the slope within 0.2%, however most amateur golfers do not have this ability.

Visualize the slope from multiple vantage points and estimate the Left-Right and Up-Down components of the slope. As a guideline 1% slope is barely perceptible. 2% is a decent slope where some break would be expected. 3% slope will correlate with a pretty crazy amount of break. 4% or more slope will lead to an unfair amount of break (normally we wouldn't put a hole on this amount of slope particularly as green speeds increase above 10).

Straddle the direct line between the ball and hole and attempt to refine the initial estimate of the component slopes using your feet.

Measure the component slopes with the app and compare measurements with estimates. There is no need to hit the putt when using this method.

Repeat the procedure for multiple positions and hole locations until measurements and estimates are reliably similar.

Model #2 for estimating slope while reading and stroking putts in a practice session:

For any particular putt, start by measuring (pacing off) the length of a putt.

Visualize the slope of the putt from multiple vantage points and estimate the Left-Right and Up-Down components of the slope. As a guideline 1% slope is barely perceptible. 2% is a decent slope where some break would be expected. 3% slope will correlate with a pretty crazy amount of break. 4% or more slope will lead to an unfair amount of break (normally we wouldn't put a hole on this amount of slope particularly as green speeds increase above 10).

Straddle the direct line between the ball and hole and attempt to refine the initial estimate of the component slopes using your feet.

Estimate the amount of break and pace required for the putt.

Measure the component slopes with the app and compare measurements with estimates. Compare your estimates for break and pace with the break and pace provided by system 100.

Stroke the putt using the break and pace provided by the system 100. Compare the results with your estimates.

Repeat the procedure for multiple positions and hole locations until measurements and estimates are reliably similar.

Model #3 for estimating slope while reading and stroking putts during play:

For any particular putt, start by measuring (pacing off) the length of a putt.

Visualize the slope of the putt from multiple vantage points and estimate the Left-Right and Up-Down components of the slope. As a guideline 1% slope is barely perceptible. 2% is a decent slope where some break would be expected. 3% slope will correlate with a pretty crazy amount of break. 4% or more slope will lead to an unfair amount of break (normally we wouldn't put a hole on this amount of slope particularly as green speeds increase above 10).

Straddle the direct line between the ball and hole and attempt to refine the initial estimate of the component slopes using your feet.

Consult the charts in the app to determine the break and pace. (Reading the charts during play is allowed. Measuring is not permitted.)

Measure the component slopes with the app and compare measurements with estimates. Compare your estimates for break and pace with the break and pace from system 100.

Stroke the putt using the break and pace provided by system 100. Compare the results with your estimates to give you feedback on your estimate of slopes, break and pace. The charts may also provide adjustments for uphill/downhill putts, where uphill putts break less than downhill putts, bumpy greens and other environmental conditions.

A critical element in reading the green for a putt is the determination of the direction of the slope around the hole. This is often called the “fall line.” The fall line is the true downward direction of the slope of the green at the hole. In other words, it is the exact, straight-line direction water would flow down the slope. The fall line is sometimes called the “zero break line” because any putt along the fall line would either be straight uphill or downhill and would have no break.

Any putt that travels directly up or down the fall line would not be expected to break to the left or right at all. Putts from either side of the fall line would be expected to break in the same downward direction as the fall line.

For any given putt, we are particularly interested in the direction of the slope between the ball and the hole. Golf holes are cut within certain industry practices and are generally on a single plane slope within 8 to 12 feet of the hole. Thus, we can approximate the fall line by measuring it at any point within some reasonable radius of the hole.

A player can practice estimating the slope of the green (including its 2-dimensional slope components) by taking a number of measurements at different points on a green. The player would then compare his own estimate with the measured slopes to refine his estimating skill. This is a valuable skill that players can use during the play of a round when measurement is not permitted.

Model #4—To determine golfers baseline putting speed based on current/actual green speed.

Firstly, determine the fall line to target hole or target location and Place ball perpendicular to fall line a specified distance away (e.g. 6 ft).

Aim putt starting line at the targeted hole.

Putt ball at the pace to end perpendicular to the target (hole) or directly beneath the target (hole). End on Ideal pace line. Ideal pace line is parallel to the fall line. The distance from the fall line varies on conditions but is normally between 8-16 inches with median on 12 on a level putt.

From the same location use system 100 to provide the target line to go into the target hole. Putt at the same pace. Adjust the green speed to provide the target break that goes in the hole.

The resulting green speed is the calibrated current green speed and may be used for different lengths of putt on the perpendicular line from the target.

Furthermore, it is possible to estimate the read of a putt based on the behavior of another player's putt. Referring to FIG. 3, if the length of the putt remains fixed, then the behavior of another player's ball may indicate the slope, break and pace of a user's ball. Placement of the ball with a fixed length of putt (as indicated by the circumference of the outer circle) allows for a plurality of reads to be provided. The break and pace will change, however, the fall line, and maximum break remain the same, regardless of the starting position of the ball along the circumference of the circle allowing for the plurality of reads.

Any variable, whether used to determine the read of a putt, or whether the resultant calculations from the read of a putt, may be used to aid a user/golfer in hitting the ball into the targeted hole. To better estimate each variable, or to better train to translate that variable into practice, other variables may be fixed. As previously indicated to better estimate green speed, the slope, the length of the putt, break and pace may be fixed, and through multiple attempts at hitting a ball to match the values provided by the graphical user interface, a user will be better able to estimate green speed. A person skilled in the art will recognize that training with respect to each variable may be accomplished by fixing the remaining variables, hitting the ball, and matching the read of the putt on the graphical user interface with that of the trajectory of the ball, start position of the ball and end position of the ball on the putting green.

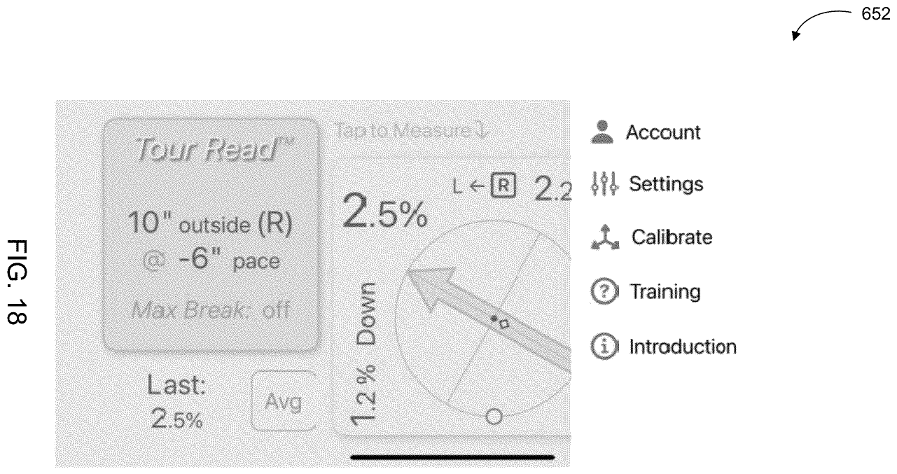

Referring to FIG. 18, there is an option of selecting a calibration mode and/or executing a calibration application. The purpose of the calibration mode is to cancel out the effects of (i) IMU 116 of system 100 being biased one way or another, (ii) system 100, where system 100 is a mobile device, being on an uneven surface or lying on a flat surface at an oblique angle, or (iii) create a baseline for interpreting the outputs of IMU 116 accurately and consistently over time to account for manufacturing tolerances and physical wear over time to IMU 116 and system 100 as a whole. In addition, in the event that the user has a case or some other form of protection around system 100, such as a mobile phone case, the calibration application will account for this. In many situations, a protective case around system 100 may affect the orientation of the device relative to the ground surface. The calibration application will compensate for this. The calibration process involves taking known relative measurements and calculating the bias as the differences in the measurements, which would be the same in a perfect system 100. An example of known relative measurements includes taking two measurements with system 100 turned 180° on the same spot. The bias may then be applied in reverse to cancel the bias out of the actual slope readings. Calibration is important and necessary as bias has been shown to be quite significant from device to device. The calibration application may also be accessed to recalibrate in the future to account for deterioration of IMU 116 or system 100 as a whole.

In the current embodiment, the calibration application includes two steps. The first step is to determine the readings based on a stationary IMU 116 and system 100. System 100 receives and monitors readings from IMU 116 while system 100 is stationary, including the user-induced acceleration of the device (acceleration that is not due to gravity). Typically, a non-zero value will be returned by the IMU 116, as each individual IMU 116 for different systems 100 may have their own manufacturing tolerances or other external factors that may limit the accuracy of each IMU 116, leading to different non-zero values across different IMUs 116 in different systems 100. The non-zero values may be considered as “IMU noise at rest”.

The second step of the calibration application is to determine a baseline for cancelling any “physical orientation bias”. This may include variations in IMU 116 placement within system 100, or the physical dimensions of system 100. In embodiments where system 100 is a mobile device, such as a smart phone, a cell phone or a tablet, IMU 116 may be located in different locations within system 100, depending on the manufacturer and the design of system 100. Furthermore, if IMU 116 is an external component it could also be located in a relatively distinct position from system 100. In addition, system 100 may come in different sizes, which may also affect the accuracy of IMU 116. The size of system 100 may further be affected should a protective case be put on it. As such, these variables with respect to the physical location and size of IMU 116 and system 100 may be overcome by monitoring outputs from IMU 116 while system 100 is placed in different known stationary orientations. As an example, system 100 may instruct a user to place system 100 on a flat surface in a landscape orientation, and record readings from IMU 116. System 100 may then instruct a user to place system 100 on a flat surface in a portrait orientation, and record readings from IMU 116. This process may be repeated with different known orientations, and by doing so, a baseline and bias-cancelling values can be created, allowing system 100 to compensate and algorithmically adjust received values from IMU 116 and display accurate readings to a user through the display of system 100. An example interaction with the calibration application through a graphical user interface is provided below.

Referring to FIG. 18, the menu provided in screenshot 652 allows a user to execute the calibration application and to calibrate system 100 and IMU 116.

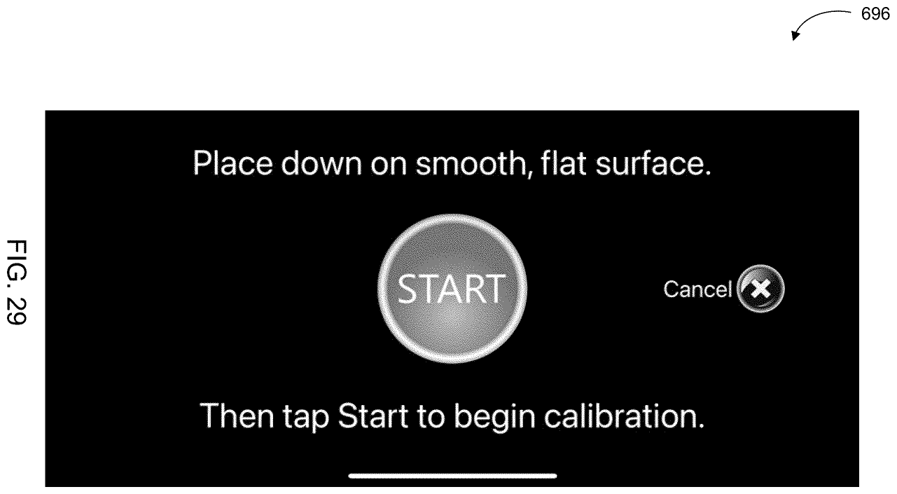

Referring to FIG. 29, screenshot 696 shows the beginning of the calibration application, where the graphical user interface instructs the user to set system 100 down on a smooth, flat surface and to tab the start button on the touch screen to begin calibration.

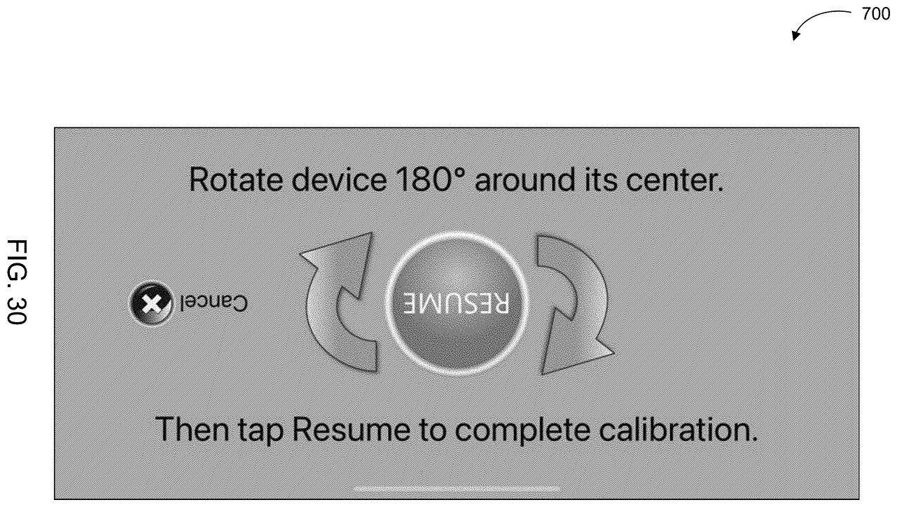

Referring to FIG. 30, after readings have been recorded in the first position as initiated by the user in FIG. 29, screenshot 700 instructs the user to rotate system 100 about its center and then to resume calibration, which instructs system 100 to further record readings from IMU 116 in the new orientation.

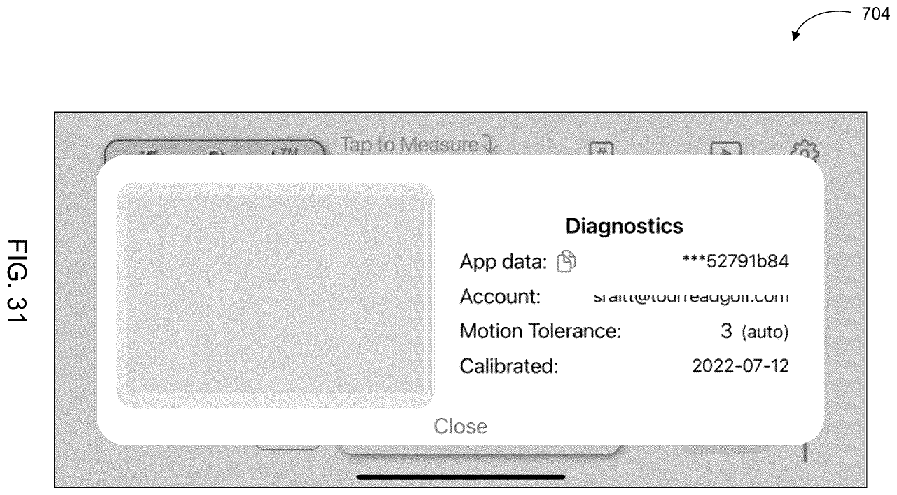

Referring to FIG. 31, screenshot 704 shows the completion of the calibration, along with the date that calibration was last performed, and any relevant application data. A person skilled in the art will recognize that there are different methods of calibrating a device to obtain accurate readings from IMU 116.

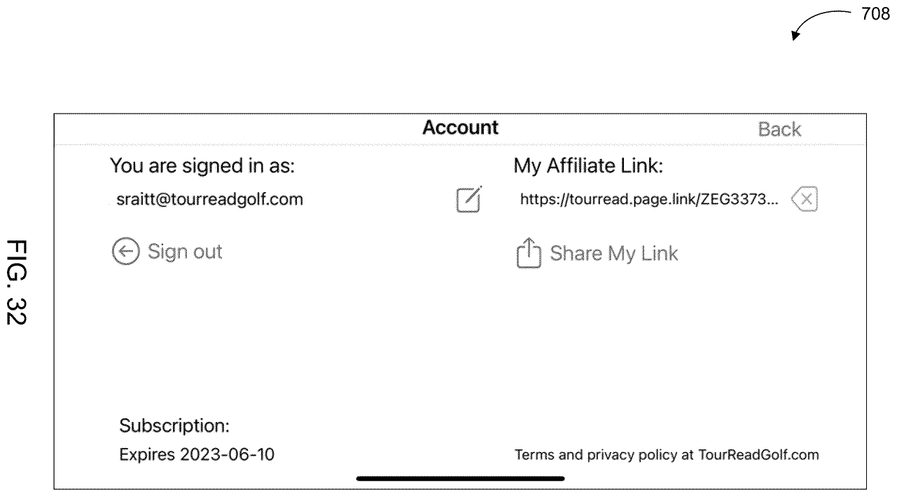

FIG. 32 depicts screenshot 708, which shows the account information pertaining to a user's account with respect to system 100.

The scope of the claims should not be limited by the embodiments set forth in the above examples, but should be given the broadest interpretation consistent with the description as a whole.

1. A method for determining a read of a putt, the method comprising:
receiving a magnitude of slope parameter, a length of putt parameter and a green speed parameter;
calculating a break and a pace based on the magnitude of slope parameter, the length of putt parameter and the green speed parameter, the read of the putt comprising the break and the pace;
determining if additional accuracy is required;
if additional accuracy is required, the magnitude of slope parameter, the length of putt parameter, or the green speed parameter may be adjusted, and the break and the pace may be re-calculated; and
if additional accuracy is not required, the break and the pace to be displayed on a graphical user interface for a user to hit a golf ball according to the read of the putt.

2. The method of claim 1, wherein the magnitude of slope parameter is measured using an inertial measurement unit.

3. The method of claim 1, wherein the length of the putt parameter is measured by taking a photograph of a distance between a starting position and a targeted hole and using image analysis to determine the distance.

4. The method of claim 1, wherein if additional accuracy is required, the method further comprising receiving a second magnitude of slope parameter, and averaging the first magnitude of slope parameter with the second magnitude of slope parameter, the averaged magnitude of slope parameter to be used in re-calculating the break and the pace.

5. A non-transitory computer-readable medium comprising instructions executable by a processor to:
receive a magnitude of slope parameter, a length of putt parameter and a green speed parameter;
determine a break and a pace based on the magnitude of slope parameter, the length of putt parameter and the green speed parameter;
receive and adjust the magnitude of slope parameter, the length of putt parameter or the green speed parameter if a user determines that the break and pace are not accurate;
re-calculate the break and the pace based on the adjusted magnitude of slope parameter, the adjusted length of putt parameter, or the adjusted green speed parameter; and
display the break and pace as a read of a putt.

6. The non-transitory computer-readable medium of claim 5, wherein the magnitude of slope parameter is measured using an inertial measurement unit.

7. The non-transitory computer-readable medium of claim 5, wherein the length of the putt parameter is measured by taking a photograph of a distance between a starting position and a targeted hole and using image analysis to determine the distance.

8. The non-transitory computer-readable medium of claim 5, the processor further configured to receive a second magnitude of slope parameter, average the second magnitude of slope parameter with the first magnitude of slope parameter, and re-calculate the break and the pace with the averaged magnitude of slope parameter.

9. A method for teaching a golfer a desired path of a golf ball to a hole on a putting green, the method comprising:
(a) placing a device at a first location on the putting green, the first location between the golf ball and the hole, and the device determining a magnitude of slope parameter, a length of putt parameter and a green speed parameter;
(b) the device calculating the desired path on the putting green based on the device determining a break and pace of the putting green for the magnitude of slope parameter, the length of putt parameter and the green speed parameter determined in step (a);
(c) displaying at least one of the desired path, the break or the pace on the device to allow the golfer to drive the golf ball to the hole;
(c) the golfer putting the ball using the break and the pace to drive the ball along the desired path to the hole; and
wherein where the ball does not reach the hole, the golfer repeating steps (a) to (c) and adjusting at least one of the magnitude of slope parameter, the length of putt parameter and the green speed parameter until the ball reaches the hole.

10. The method of claim 9, wherein the magnitude of slope parameter is measured using an inertial measurement unit.
